(19) United States
(12) Patent Application Publication
(10) Pub. No.: US 2025/0358382 A1
(43) Pub. Date: Nov. 20, 2025

(54) NON-PLANAR BEAMFORMED LOUDSPEAKER FOR DISPLAY DEVICES

(71) Applicant: DOLBY LABORATORIES LICENSING CORPORATION

(72) Inventors: Benjamin Alexander JANCOVICH, Arncliffe (AU); Lane Patrick MILLER, Cornulla (AU); Kelvin Francis GRIFFITHS, Porthcawl (GB)

(73) Assignee: DOLBY LABORATORIES LICENSING CORPORATION, (US)

(21) Appl. No.: 18/874,372

(22) PCT Filed: Jun. 16, 2023
(86) PCT No.: PCT/US2023/068576

§ 371 Date: Dec. 12, 2024

Related U.S. Application Data
(60) Provisional application No. 63/353,142, filed on Jun. 17, 2022.

(30) Foreign Application Priority Data
Jun. 17, 2022 (EP) 22179604.8

(51) Int. Cl. H04N 5/64; H04R 1/02; H04R 3/12; H04R 5/02

(52) U.S. Cl. CPC H04N 5/64; H04R 1/025; H04R 3/12; H04R 5/02; H04R 2203/12; H04R 2499/15

(57) ABSTRACT

A display device including a first surface that supports a display and a second surface disposed opposite to first surface. A first speaker module is supported by the second surface and includes a first speaker arranged to face in a first direction relative to the display device and a second speaker arranged to face in a second direction relative to the display device, the second direction being different than the first direction. A second speaker module is supported by the rear surface and includes a third speaker arranged to face in the first direction and a fourth speaker arranged to face in the second direction. Sound energy emitted by the first and second speaker modules is beamformed by filters that were designed in consideration of the effects of sound reflection off surfaces adjacent to the display device.

### CROSS-REFERENCE TO RELATED APPLICATIONS

This application claims priority of the following priority applications: U.S. provisional application 63/353,142, filed 17 Jun. 2022, and European application 22179604.8 filed 17 Jun. 2022, each of which is incorporated by reference in its entirety.

### BACKGROUND

### 1. Field of the Disclosure

This application relates generally to speaker modules for display devices, such as televisions, and methods for designing speaker modules for display devices, such as televisions, monitors, and other flatscreen devices.

### BRIEF SUMMARY OF THE DISCLOSURE

Largely for aesthetic purposes, industrial designers do not allow for televisions or other flatscreen display devices to include front facing speakers. Thus, televisions often include speakers that emit sound energy in directions away from, not towards, the viewers. The firing of speaker drivers in directions away from a viewer degrades the quality of sound experienced by the viewer. Thus, a speaker design for televisions and other display devices that improves a viewer's listening experience by directing the emitted sound energy towards the viewer is desired.

Various aspects of the present disclosure relate to speaker modules, systems, and methods for designing speaker modules for a display device, such as a television.

In one example aspect of the present disclosure, there is provided a display device including a first surface that supports a display and a second surface disposed opposite to first surface. A first speaker module is supported by the second surface and includes a first speaker arranged to face in a first direction relative to the display device and a second speaker arranged to face in a second direction relative to the display device, the second direction being different than the first direction. A second speaker module is supported by the rear surface and includes a third speaker arranged to face in the first direction and a fourth speaker arranged to face in the second direction.

In another example aspect of the present disclosure, there is provided a method for designing filters for use with a speaker module for a display device. The speaker module includes a first speaker oriented to face in a first direction, a second speaker oriented to face in a second direction orthogonal to the first direction, a first filter connected to the first speaker, and a second filter connected to the second speaker. The method includes obtaining a three-dimensional computer model of the speaker module that includes a model of the first speaker and a model of the second speaker, determining a first complex polar frequency response of the first speaker based on the computer model of the speaker module, and determining a second complex polar frequency response of the second speaker based on the computer model of the speaker module. The method further includes defining a target response of a combined output of the first and second speakers, determining a first set of parameters of the first filter based on the target response and the first and second complex polar frequency responses, and determining a second set of parameters of the second filter based on the target response and the first and second complex polar frequency responses.

In another example aspect of the present disclosure, there is provided a non-transitory computer-readable medium storing instructions that, when executed by a processor cause the processor to perform operations for designing filters for use with a speaker module for a display device. The speaker module includes a first speaker oriented to face in a first direction, a second speaker oriented to face in a second direction orthogonal to the first direction, a first filter connected to the first speaker, and a second filter connected to the second speaker. The method includes obtaining a three-dimensional computer model of the speaker module that includes a model of the first speaker and a model of the second speaker, determining a first complex polar frequency response of the first speaker based on the computer model of the speaker module, and determining a second complex polar frequency response of the second speaker based on the computer model of the speaker module. The method further includes defining a target response of a combined output of the first and second speakers, determining a first set of parameters of the first filter based on the target response and the first and second complex polar frequency responses, and determining a second set of parameters of the second filter based on the target response and the first and second complex polar frequency responses.

### DESCRIPTION OF THE DRAWINGS

These and other more detailed and specific features of various instances are more fully disclosed in the following description, reference being had to the accompanying drawings, in which:

FIG. 1 illustrates an example perspective view of a television according to various aspects of the present disclosure;

FIG. 2 illustrates example perspective view of a television according to various aspects of the present disclosure;

FIG. 3 illustrates an example rear view of a television according to various aspects of the present disclosure;

FIG. 4 illustrates an exploded view of an example speaker module according to various aspects of the present disclosure;

FIG. 5 illustrates a circuit diagram of an example speaker module according to various aspects of the present disclosure;

FIG. 6 illustrates a circuit diagram of an example speaker module according to various aspects of the present disclosure;

FIG. 7 illustrates a side view of a television according to various aspects of the present disclosure;

FIG. 8 illustrates an example perspective view of a television according to various aspects of the present disclosure;

FIG. 9 illustrates a side view of a television according to various aspects of the present disclosure;

FIGS. 10A and 10B illustrate acoustic summations of sound energy emitted by speakers according to various aspects of the present disclosure;

FIG. 11 illustrates a method of designing a speaker filter according to various aspects of the present disclosure;

FIG. 12 illustrates a block diagram of a computing device according to various aspects of the present disclosure;

FIG. 13 illustrates complex frequency response evaluation points according to various aspects of the present disclosure;

FIG. 14A-B illustrate respective example spatial pressure radiation patterns of a non-beamformed rear firing speaker and a non-beamformed down firing speaker according to various aspects of the present disclosure; and

FIG. 15 illustrates an example spatial pressure radiation pattern of a beamformed speaker module according to various aspects of the present disclosure.

### DETAILED DESCRIPTION

This disclosure and aspects thereof can be embodied in various forms, including hardware or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as details regarding display devices, speaker configurations, digital filters, and the like, in order to provide an understanding of one or more aspects of the present disclosure. It will be readily apparent to one skilled in the art that these specific details are merely examples and not intended to limit the scope of this application.

Moreover, while the present disclosure focuses mainly on examples in which the display device is a television positioned in front of a wall and/or above a supporting surface, it should be understood that this is merely one example of an implementation. It will further be understood that the disclosed systems and methods can be used in other types of flatscreen display devices, such as computer monitors, provided that the distance between the flatscreen display device and adjacent surfaces (e.g., a rear-wall, a surface underneath the display device, a floor, a ceiling, etc.) is known or can be measured. When the respective distances between the display device and the rear wall behind the display device and/or surface underneath the display device are known, beamforming filters included in the display device can be designed offsite before the display device is installed.

Furthermore, it should be understood the disclosed systems and methods can be used for a display device even if the distance between the display device and adjacent surfaces (e.g., a rear-wall, a surface underneath the display device, a floor, a ceiling, etc.) are unknown prior to installation of the display device. In such instances, the respective distances between the display device and the adjacent surfaces can be measured and the beamforming filters for the display device speakers can be designed onsite at the installation location. For example, the beamforming filters could be designed using a cloud-based finite element method (FEM)/boundary element method (BEM) model and optimization procedure. In such an example, a user measures, scans, the geometry of the display device, the speakers, and the surrounding objects using a three-dimensional (3-D) scanner, such as a smartphone that includes a camera with depth sensing measurement device (e.g., a smartphone with a 3-D scanning capabilities). The 3-D geometry scan would then be provided to the FEM/BEM model for simulation of the display device speakers within a 3-D model that accurately represents the playback environment in which the display device is located. In another example, the complex spatial frequency response of the display device speakers could be measured on-site using a large microphone array or a microphone supported by moving surface (e.g., a robot arm or a turntable). In such an example, the measured complex spatial frequency response of the display device speakers may be used to design the beamforming filters on-site. Accordingly, in some instances, The onsite design of beamforming filters may allow for more accurate tuning of the filters to the specific acoustic environment in which the display device is installed, thereby negating a need for a standardized and/or a predefined wall-to-display device distance.

### Speaker Module Design

As described above, display devices such as televisions often include speakers that emit sound energy in directions away from, not towards, the viewers. When sound energy is emitted by the display device speakers in one or more directions away from the viewer, the sound energy is directed towards adjacent surfaces such as walls behind or to the side of the display device, supporting surfaces, such as tables and cabinets, located underneath the display device, the floor, and/or the ceiling. Sound energy reflected off these surfaces is combined with sound energy arriving at the viewer via the direct path, thereby causing constructive and destructive interferences that cause undesirable peaks and/or notches in the complex frequency response of sound energy at the viewer's position.

To address these undesirable acoustic interferences, some speakers employ large equalization (EQ) gains to their emitted sound energy. However, applying large EQ gains to the emitted sound energy means that even more sound energy is directed into the adjacent boundaries, thereby exacerbating the issues caused by the constructive and destructive interferences, and further exciting the room's natural reverberant qualities. Accordingly, to reduce a need for excessive equalization, the proposed speakers and speaker modules described herein are designed to reduce an amount of sound energy directed towards surfaces adjacent the display device and, instead, increase the amount sound energy directed towards the viewer of the display device.

Reducing the amount of sound energy directed at tables, cabinets, walls, the floor, and the ceiling provides the added benefit of reducing a magnitude of late arriving copies of the direct sound at the viewer's position, which negatively influence spatial perception and speech intelligibility of the sound. A critical component of speech intelligibility requires that any short, silent gaps in between speech consonants remain quiet relative to the level of the speech. However, if the direct-to-reverberant ratio of sound energy is low at the viewer's position, the “gaps” will be filled with reverberation from the previous consonant. The above described constructive and destructive interferences caused by sound energy reflected of surfaces adjacent to the display device cause reduction in the direct-to-reverberant ratio at the viewer's position, and thus, reduce the speech intelligibility of sound energy emitted by the displace display. Accordingly, the proposed speakers and speaker modules described herein further improve the direct-to-reverberant ratio experienced at the viewer's position by directing an acoustic sum of emitted sound energy away from adjacent surfaces and towards the viewer of the display device.

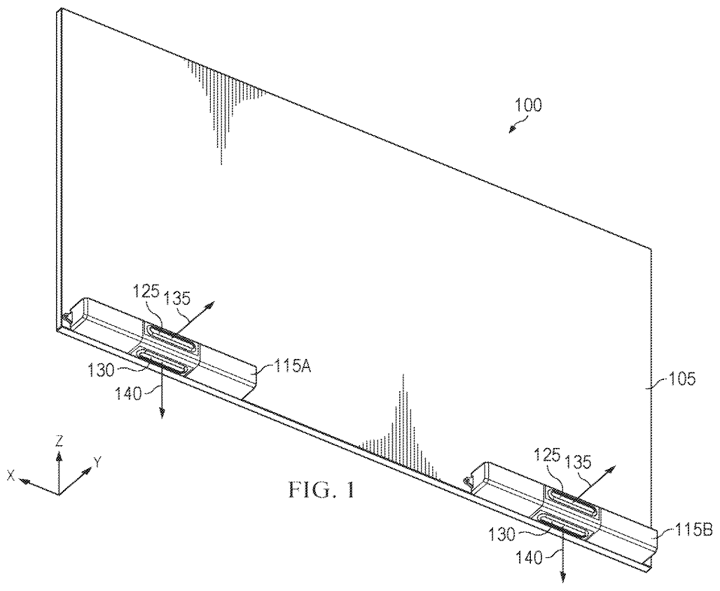

FIGS. 1-3 illustrate perspective and rear views of a display device 100 that includes a proposed speaker design according to some examples of the present disclosure. Although the display device 100 is illustrated as a television, it should be understood that the description of the display device 100 is equally applicable to other types of flatscreen display devices that include speakers, such as computer monitors.

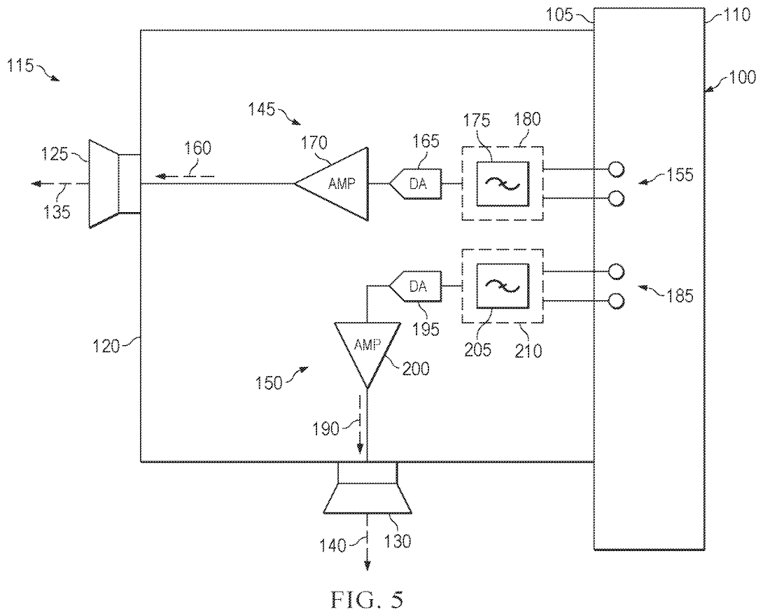

The display device 100 includes a rear surface 105, which is disposed opposite to a front surface 110 (FIGS. 5-7) that supports the display (e.g., television screen). As shown, the rear surface 105 supports a first speaker module 115A and a second speaker module 115B. In particular, the first speaker module 115A is supported on a first side of the rear surface 105 of the display device 100. The second speaker module 115B is supported on a second side, opposite to the first side, of the rear surface 105 of the display device 100. For example, with respect to FIGS. 1-3, the first speaker module 115A is supported on the lower left side of the rear surface 105 and the second speaker module 115B is supported on the lower right side of the rear surface 105. In some instances, the first and second speaker modules 115A, 115B are mounted to the rear surface 105. In other instances, the first and second speaker modules 115A, 115B are integrated within the rear surface 105. For example, in such instances, the first speaker module 115A may be flush with the rear surface 105 and/or a bottom surface of the display device 100. As another example, the second speaker module 115B may be flush with the rear surface 105 and/or a bottom surface of the display device 100. Although described as including two speaker modules 115A, 115B, it should be understood that the display device 100 may include more or fewer than two speaker modules 115. In some instances, the mounting positions of the speaker modules 115A, 115B are varied with respect to the surface area of the rear surface 105. That is, in some instances, the speaker modules 115A, 115B are mounted at other locations on the rear surface 105.

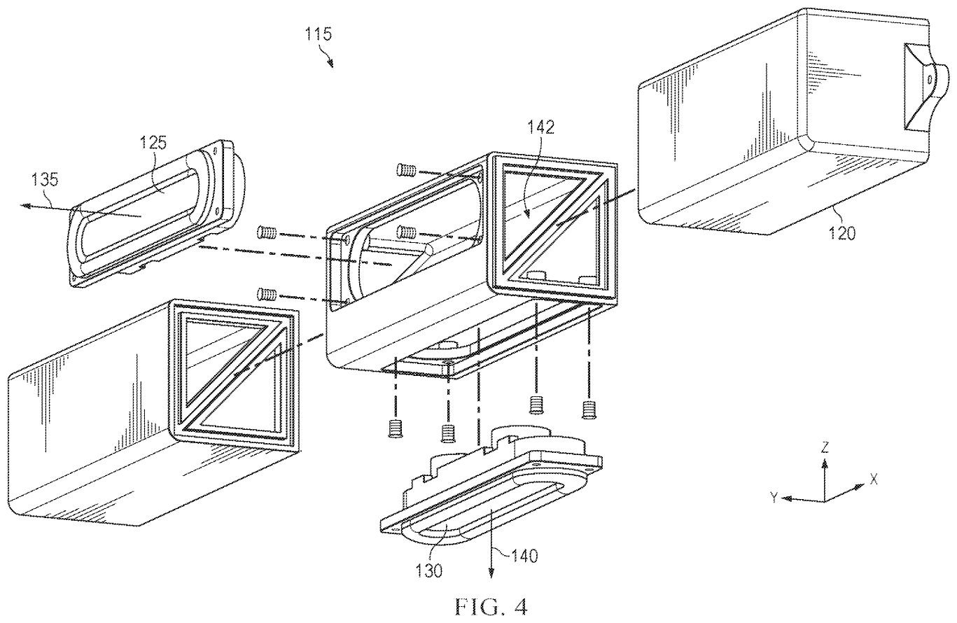

In some instances, the first and second speaker modules 115A, 115B are identical in construction, and thus, each of the first and second speaker modules 115A, 115B may hereinafter be referred to as a “speaker module 115.” FIG. 4 illustrates an exploded view of a single speaker module 115. The speaker module 115 includes a housing 120 that supports a first transducer, or speaker, 125 and a second transducer, or speaker, 130. As shown, the first speaker 125 is oriented to face in a first direction 135 relative to the display device 100 and the second speaker 130 is oriented to face in a second direction 140 relative to the display device 100. In the illustrated example, the first direction 135 in which the first speaker 125 faces is orthogonal to the second direction 140 in which the second speaker 130 faces. Accordingly, the first speaker 125 is oriented to emit sound energy in a direction (e.g., the first direction 135) that is orthogonal to the direction (e.g., the second direction 140) in which the second speaker 130 emits sound energy. With respect to the coordinate axis illustrated in FIGS. 1-4, the first direction 135 is along the y-axis and the second direction 140 is along the z-axis. In some embodiments, the housing 120 further includes an internal wall 142 that separates the rear radiation cavities of the first and second speakers 125, 130. This internal wall 142 ensures that the back pressure of one speaker (e.g., the first speaker 125) does not influence the motion of the other speaker (e.g., the second speaker 130).

Although the direction in which the first speaker 125 faces is described above as being orthogonal to the direction in which the second speaker 130 faces, in some instances, the first speaker 125 is oriented at a different angle relative to the second speaker 130. That is, in some instances, the first speaker 125 may be oriented to face in a direction that is not orthogonal to the direction in which the second speaker 130 faces. Therefore, in such instances, the direction in which the first speaker 125 faces and emits sound energy may not be orthogonal to the direction in which the second speaker 130 faces and emits sound energy. For example, the first speaker 125 may be oriented to face and/or emit sound energy in a direction that differs from the direction in which the second speaker 130 faces and/or emits sound energy by an angle (e.g., 85 degrees, 75 degrees, 50 degrees, etc.) that is more or less than 90 degrees. Accordingly, the orthogonal orientation of the first and second speakers 125, 130 is just one possible implementation described herein.

FIG. 5 illustrates an exemplary circuit diagram included in a speaker module 115. As shown, the first speaker 125 and the second speaker 130 are included in separately driven speaker circuits. That is, the first speaker 125 is included in a first speaker circuit 145 and the second speaker 130 is included in a second speaker circuit 150. In addition, although the mechanical enclosure of the first speaker 125 (e.g., portion of the speaker module housing 120 that contains the first speaker 125) is conjoined with the mechanical enclosure of the second speaker (e.g., portion of the speaker module housing 120 that contains the second speaker 130), the respective mechanical enclosures of the first and second speakers 125, 130 are acoustically independent. That is, the first speaker 125 operates in a back volume that is separate from the acoustic back volume of the second speaker 130. For example, the separate acoustic back volumes of the first and second speakers 125, 130 is achieved with the inclusion of internal wall 142 in the housing 120.

It should be understood that the configuration of the first speaker circuit 145 is provided as an example and not intended to limit implementation of the proposed speaker module 115 in any way. Moreover, it should be understood that in practice, the number and orientation of the components included in the first speaker circuit 145 may be different. In the illustrated example, the first speaker circuit 145 is configured to convert one or more input signals 155 into a first driving signal 160 for driving the first speaker 125. The one or more input signals 155 may be, for example, signals that include audio content to be played by the first speaker 125, input power signals, and/or other types of signals.

In the illustrated example, the first speaker circuit 145 includes a first digital-to-analog (D-A) converter 165, a first amplifier (amp) 170, and a first beamforming (BF) filter 175. In operation, the first BF filter 175 applies one or more phase shifts and/or complex gains to the input signals 155. The first D-A converter 165 converts the digital signals output by the first BF filter 175 into to analog signals, which are amplified by the first amp 170 before being provided as the first driving signal 160 to the first speaker 125. Although the first speaker circuit 145 is illustrated as being contained within the housing of the speaker module 115, it should be understood that in some instances, one or more components included in the first speaker circuit 145 are contained within the display device 100 and electrically connected to the first speaker 125.

In the illustrated example, the first speaker circuit 145 further includes a first digital signal processor (DSP) 180. Although the first DSP 180 is illustrated as being contained within the housing of the speaker module 115, it should be understood that in some instances, the first DSP 180 is contained within the display device 100 and electrically connected to the first speaker circuit 145. In some instances, the first DSP 180 and the second DSP 210 described herein are implemented as a single DSP that is configured to separately and independently drive the first and second speaker circuits 145, 150. In some instances, one or more components of the first speaker circuit 145 are included in or otherwise implemented by the first DSP 180. For example, in some instances, one or more of the first D-A converter 165, the first amp 170, and the first BF filter 175 are included in or otherwise implemented by the first DSP 180.

In the illustrated example, the first BF filter 175 is implemented as a digital filter, such as a finite impulse response (FIR) filter, included in the first DSP 180. As will be described in more detail below, the first BF filter 175 is configured to apply one or more frequency dependent phase shifts and/or frequency dependent gains to the signals used to drive the first speaker 125. Hereinafter, the application of frequency dependent phase shifts and/or frequency dependent gains to the signals used to drive the first speaker 125 may be referred to as applying frequency dependent phase shifts and/or frequency dependent gains to the sound energy emitted by the first speaker 125. In some instances, the first BF filter 175 is implemented in the frequency domain and uses complex gains to modify audio content that is to be played back by the first speaker 125. As will be described in more detail below, the first BF filter 175 is configured to apply one or more frequency dependent phase shifts and/or frequency dependent gains to the sound energy emitted by the first speaker 125 such that an acoustic sum of the sound energy emitted by the first and second speakers 125, 130 is directed in a targeted beam towards a viewer of the display device 100.

Similar to the first speaker circuit 145, it should be understood that the illustrated configuration of the second speaker circuit 150 is provided as an example and not intended to limit implementation of the proposed speaker module 115 in any way. Moreover, it should be understood that in practice, the number and orientation of the components included in the second speaker circuit 150 may be different. In the illustrated example, the second speaker circuit 150 is configured to convert one or more input signals 185 into a second driving signal 190 for driving the second speaker 130. The one or more input signals 185 may be, for example, signals that include audio content to be played by the second speaker 130, input power signals, and/or other types of signals.

In the illustrated example, the second speaker circuit 150 includes a second D-A converter 195, a second amplifier (amp) 200, and a second BF filter 205. In operation, the second BF filter 205 applies one or more frequency dependent phase shifts and/or frequency dependent gains to the input signals 185. The second D-A converter 195 converts the digital signals output by the second BF filter 205 into to analog signals, which are amplified by the second amp 200 before being provided as the second driving signal 190 to the second speaker 130. Although the second speaker circuit 150 is illustrated as being contained within the housing of the speaker module 115, it should be understood that in some instances, one or more components included in the second speaker circuit 150 are contained within the display device 100 and electrically connected to the second speaker 130.

In the illustrated example, the second speaker circuit 150 further includes a second DSP 210. Although the second DSP 210 is illustrated as being contained within the housing of the speaker module 115, it should be understood that in some instances, the second DSP 210 is contained within the display device 100 and electrically connected to the second speaker circuit 150. As described above, in some instances, the first DSP 180 and the second DSP 210 described herein are implemented as a single DSP that is configured to separately drive the first and second speaker circuits 145, 150. In some instances, one or more components of the second speaker circuit 150 are included in or otherwise implemented by the second DSP 210. For example, in some instances, one or more of the second D-A converter 195, the second amp 200, and the second BF filter 205 are included in or otherwise implemented by the second DSP 210.

In the illustrated example, the second BF filter 205 is implemented as a digital filter, such as an FIR filter, included in the second DSP 210. As will be described in more detail below, the second BF filter 205 is configured to apply one or more frequency dependent phase shifts and/or frequency dependent gains to signals used to drive the second speaker. Hereinafter, the application of frequency dependent phase shifts and/or frequency dependent gains to the signals used to drive the second speaker 130 may be referred to as applying frequency dependent phase shifts and/or frequency dependent gains to the sound energy emitted by the second speaker 130. In some instances, the second BF filter 205 is implemented in the frequency domain and uses complex gains to modify, or filter, audio content that is to be played back by the second speaker 130. As will be described in more detail below, the second BF filter 205 is configured to apply one or more frequency dependent phase shifts and/or frequency dependent gains to the sound energy emitted by the second speaker 130 such that an acoustic sum of the sound energy emitted by the first and second speakers 125, 130 is directed in a targeted beam towards a viewer of the display device 100.

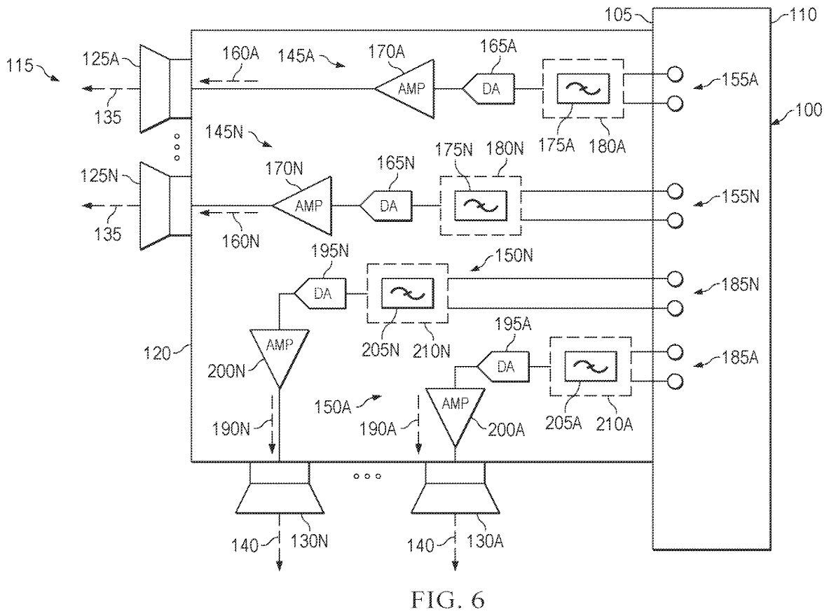

Although the speaker module 115 is illustrated in FIG. 5 and described as including a single first speaker 125 that is oriented to face in the first direction 135 and a single second speaker 130 that is oriented to face in the second direction 140, it should be understood that in some instances, the speaker module 115 includes a plurality, or array, of first speakers 125A-125N and a plurality, or array, of second speakers 130A-135N (see FIG. 6). Accordingly, it should be understood that examples of a speaker module 115 that includes a single first speaker 125 and a single second speaker 130 described herein are also applicable to speaker modules 115 that include a plurality of first speakers 125A-125N and a plurality of second speakers 130A-130N. Thus, hereinafter, a speaker module 115 may be described at times as including first speaker(s) 125 (e.g., one or more first speakers 125) and second speaker(s) 130 (e.g., one or more second speakers 130). Regardless of how many first speakers 125A-125N are included in a speaker module 115, it should be understood that each of the plurality of first speakers 125A-125N are independently driven and independently filtered. Likewise, regardless of how many second speakers 130A-130N are included in a speaker module 115, it should be understood that each of the plurality of first speakers 130A-130N are independently driven and independently filtered.

In some instances, each of the plurality of first speakers 125A-125N are oriented to face in the same direction, such as the first direction 135. In some instances, each of the plurality of first speakers 125A-125N are oriented to face in different directions. In some instances, only some of the plurality of first speakers 125A-125N are oriented to face in the same direction. In one example, the plurality of first speakers 125A-125N are arranged to face in an equal plurality of directions around an arc, such as a quarter circle, with angle increments spaced between each of the plurality of first speakers 125A-125N. In such an example, if the speaker module 115 includes six first speakers 125A-125F, the six first speakers 125A-125F may respectively be oriented to fire at 0 degrees, 18 degrees, 36 degrees, 54 degrees, 72 degrees, and 90 degrees about the quarter circle.

Similarly, in some instances, the plurality of second speakers 130A-130N are oriented to face in the same direction, such as the second direction 140. In some instances, the plurality of second speakers 130A-130N are oriented to face in different directions. In some instances, only some of the plurality of second speakers 130A-130N are oriented to face in the same direction. In one example, the plurality of second speakers 130A-130N are arranged to face in an equal plurality of directions around an arc, such as a quarter circle, with angle increments spaced between each of the plurality of second speakers 130A-130N. In such an example, if the speaker module 115 includes six second speakers 130A-130F, the six second speakers 130A-130F may respectively be oriented to fire at 0 degrees, 18 degrees, 36 degrees, 54 degrees, 72 degrees, and 90 degrees about the quarter circle.

As further shown in the illustrated example of FIG. 6, each of the plurality of first speakers 125A-125N is electrically connected to and driven by a respective first D-A converter 165A-165N, a respective first amp 170A-170N, and a respective first BF filter 175A-175N. As will be described in more detail below, the first BF filters 175A-175N are configured to apply respective phase shifts and/or complex gains to the sound energy emitted by respective first speakers 125A-125N to which they are connected such that the acoustic sum of sound energy emitted by the first speakers 125A-125N is directed, or steered, towards the viewer of display device 100. Moreover, the plurality of first BF filters 175A-175N are designed such that the acoustic sum of the sound energy emitted by the first speakers 125A-125N and the sound energy emitted by the second speakers 130A-130N is directed in a beam of sound energy towards the viewer of display device 100. It should be understood that the illustrated configurations of the plurality of first speaker circuits 145A-145N are provided as an example and not intended to limit implementation of the proposed speaker module 115 in any way. Moreover, it should be understood that in practice, the number and orientation of the components included in the first speaker circuits 145A-145N may be different.

Similarly, each of the plurality of second speakers 130A-130N is electrically connected to and driven by a respective second D-A converter 195A-195N, a respective second amp 200A-200N, and a respective second BF filter 205A-205N. As will be described in more detail below, the second BF filters 205A-205N are configured to apply respective frequency dependent phase shifts and/or frequency dependent gains to the sound energy emitted by respective second speakers 130A-130N to which they are connected such that the acoustic sum of sound energy emitted by the second speakers 205A-205N is directed, or steered, towards the viewer of display device 100. Moreover, the plurality of second BF filters 205A-205N are designed such that the acoustic sum of the sound energy emitted by the first speakers 125A-125N and the sound energy emitted by the second speakers 130A-130N is directed in a beam of sound energy towards the viewer of display device 100. It should be understood that the illustrated configurations of the plurality of second speaker circuits 150A-150N are provided as an example and not intended to limit implementation of the proposed speaker module 115 in any way. Moreover, it should be understood that in practice, the number and orientation of the components included in the second speaker circuits 150A-150N may be different.

As described above with respect to FIGS. 1-4, the first speaker 125 is oriented to face in a first direction 135 relative to the speaker module 115, and the second speaker 130 is oriented to face in a second direction 140 relative to the speaker module 115, the second direction 140 being generally orthogonal to the first direction 135. In some instances, an angle between the first direction 135 and the second direction 140 is less than 90 degrees. In some instances, an angle between the first direction 135 and the second direction 140 is greater than 90 degrees.

In instances in which the speaker module 115 includes a plurality of first speakers 125A-125N and a plurality of second speakers 130A-130N, one or more of the plurality of first speakers 125A-125N are oriented to face in a first general direction (e.g., the first direction 135) relative to the speaker module 115, and one or more of the plurality of second speakers 130A-130N are oriented to face in a second general direction (e.g., the second direction 140) relative to the speaker module 115. In some instances, the first general direction is orthogonal to the second general direction. In some instances, the angle between the first general direction and the second general direction is less than 90 degrees. In some instances, the angle between the first general direction and the second general direction is greater than 90 degrees. In some instances, one or more of the plurality of first speakers 125A-125N are oriented to face in different directions relative to the speaker module 115, and one or more of the plurality of second speakers 130A-130N are oriented to face in different directions relative to the speaker module 115.

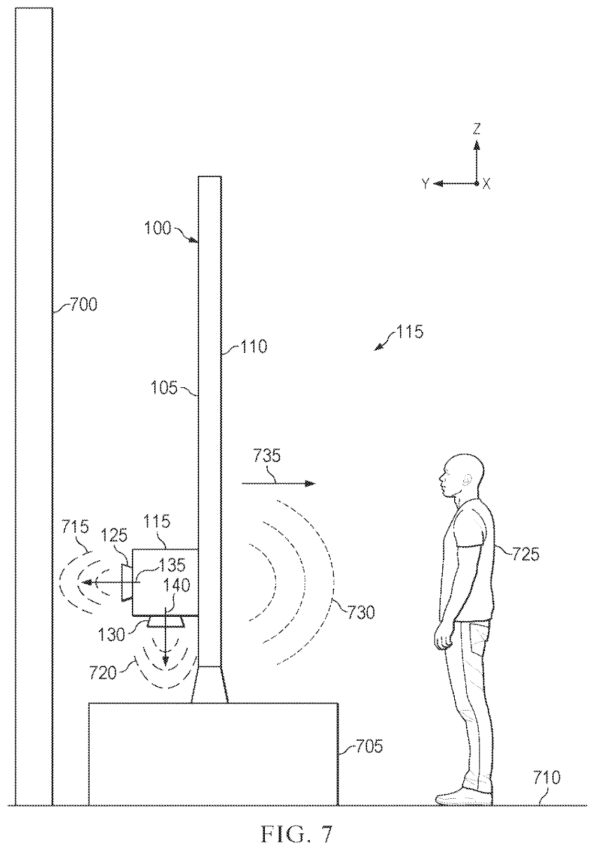

FIGS. 1-3 illustrate a first possible arrangement of the first and second speaker modules 115A, 115B relative to the rear surface 105 of display device 100. As shown, the speaker modules 115A, 115B are arranged such that the respective first speakers 125 included in the speaker modules 115A, 115B are oriented to face in the same direction as the rear surface 105 of display device 100. That is, the first speakers 125 are rearward facing relative to the display device 100, such that the first speakers 125 emit sound energy in a direction that is generally behind the rear surface 105 and away from a viewer of display device 100 (e.g., along the y-axis). As shown in FIG. 7, when the speaker modules 115A, 115B are configured in this arrangement, the sound energy emitted by the first speakers 125 is directed towards a wall 700 that is located behind the display device 100. The wall 700 reflects some of the sound energy emitted by the first speaker 125 back towards display device 100. The first speakers 125 may hereinafter be referred to as rear firing speakers 125 when describing the arrangement of speaker modules 115A, 115B illustrated in FIGS. 1-3 and 7.

However, simply aiming the rear firing speakers 125 towards the wall 700 and reflecting the sound energy emitted by the rear firing speakers 125 off the wall 700 does not alone result in a redirection of sound energy towards viewers 725 positioned in front of the display device 100. Rather, it is the combined interactions between the beamformed outputs of the rear firing speakers 125, the beamformed outputs of the second, or down firing, speakers 130, and the reflections of sound energy off adjacent surfaces that result in the propagation of the total sound field towards the viewers 725. Accordingly, the reflection of sound energy of the wall 700 participates in the beamforming array of sound energy directed towards the viewers 725, but only does so in a beneficial way if the outputs of the rear firing speakers 125 are beam-formed using first BF filters 175A-175N that are designed using data that accounts for the presence of such reflections off adjacent surfaces. If the first BF filters 175A-175N are designed without considering the effects the interaction between sound energy emitted by the speakers 125,130 and reflections off of adjacent boundaries, the effects of the sound reflection off the wall 700 would most likely be detrimental to overall system performance and listening experience of the viewers 725 positioned in front of the display device 100. Processes and/or methods for designing the first BF filters 175A-175N will be described in more detail below.

As further shown in the speaker module arrangement of FIGS. 1-3 and 7, the speaker modules 115A, 115B are arranged such that the respective second speakers 130 included in the speaker modules 115A, 115B are oriented to face in a downward direction relative to display device 100 (e.g., along the z-axis). That is, the second direction 140 in which the second speakers 130 emit sound energy is approximately 90 degrees rotationally offset from the direction in which the rear facing first speakers 125 emit sound energy. When the speaker modules 115A, 115B are configured in this arrangement, the sound energy emitted by the second speakers 130 is directed downward towards a surface, such as a cabinet, table, or other supporting surface, 705 that supports and/or is located beneath the bottom of display device 100. The surface 705 reflects some of the sound energy emitted by the second speakers 130 upward towards display device 100 and forward towards viewers 725 positioned in front of the display device 100. The second speakers 130 may hereinafter be referred to as down firing speakers 130 when describing the arrangement of speaker modules 115A, 115B illustrated in FIGS. 1-3 and 7.

Similar to the above description of sound energy reflected off the wall 700, simply aiming the down firing speakers 130 towards the surface 705 beneath the display device 100 and reflecting the sound energy emitted by the down firing speakers 130 off the surface 705 does not alone result in a redirection of sound energy towards viewers 725 positioned in front of the display device 100. Rather, it is the combined interactions between the beamformed outputs of the rear firing speakers 125, the beamformed outputs of the down firing speakers 130, and the reflections of sound energy off adjacent surfaces that result in the propagation of the total sound field towards the viewers 725. Accordingly, the reflection of sound energy of the surface 705 participates in the beamforming array of sound energy directed towards the viewers 725, but only does so in a beneficial way if the outputs of the down firing speakers 130 are beam-formed using second BF filters 205A-205N that are designed using data that accounts for the presence of such reflections off adjacent surfaces. If the second BF filters 205A-205N are designed without considering the effects the interaction between sound energy emitted by the speakers 125,130 and reflections off of adjacent boundaries, the effects of the sound reflection off the surface 705 would most likely be detrimental to overall system performance and the listening experience of the viewers 725 positioned in front of the display device 100. Processes and/or methods for designing the second BF filters 205A-205N will be described in more detail below.

In summary, FIG. 7 illustrates a side view of the display device 100 in which the speaker modules 115A, 115B are arranged such that the first speakers 125 are rear firing speakers and the second speakers 130 are down firing speakers. A first sound energy 715 emitted by the rear firing speakers 125 is generally directed towards the wall 700 located behind display device 100. Similarly, a second sound energy 720 emitted by down firing speakers 130 is generally directed downward towards the surface 705 (e.g., a cabinet) that supports and/or is located underneath display device 100. However, since a viewer 725 would be positioned in front of the display device 100 when watching the display device 100, a desired, or target, sound energy 730 emitted by the speaker modules 115A, 115B would be directed towards the viewer 725. That is, even though the rear firing speakers 125 emit the first sound energy 715 in the first direction 135 rearward from the display device 100 and the down firing speakers 130 emit the second sound energy 720 in the second direction 140 downward form the display device 100, the target sound energy 730 emitted by the speaker modules 115A, 115B should travel in a third, or target, direction 735 towards a viewer 725 positioned in front of display device 100.

As will be described in more detail below, the first and second BF filters 175, 205 included in a speaker module 115 are designed such that the acoustic summation of first and second sound energies 715, 720 emitted by the first and second speakers 125, 130, along with the reflections from adjacent boundaries, are formed, or steered, into a target beam of sound energy 730 directed towards the viewer 725. That is, the frequency dependent gains and/or frequency dependent phase shifts applied by the first and second BF filters 175, 205 to the first and second sound energies 715, 720, in combination with the reflection of sound off the wall 700, the surface 705, and other surfaces adjacent the display device 100, results in a beam of sound energy 730 directed towards viewer 725. Accordingly, this resultant beam of sound energy 730 that generally forms in the target direction 735 towards the viewer 725 experiences the intended constructive and destructive interferences in comparison to the scenario in which no BF filters 175, 205 are applied to the first and second speakers 125, 130. Thus, the target directivity (e.g., target direction 735) of emitted sound energy that is achieved with the application of the first and second BF filters 175, 205 improves the direct-to-reverberant ratio experienced at the position of viewer 725 and reduces the need for excessive sound EQ.

Although FIGS. 1-3 and 7 illustrate an example in which the speaker modules 115A, 115B include rear firing speakers 125 that emit sound energy in a rearward direction and down firing speakers 130 that emit sound energy in an orthogonal, downward direction, it should be understood that, in some instances, the speaker modules 115A, 115B may be arranged in other manners relative to the rear surface 105 of display device 100. Thus, in some instances, the first and second speakers 125, 130 may be arranged to emit sound energy in other directions.

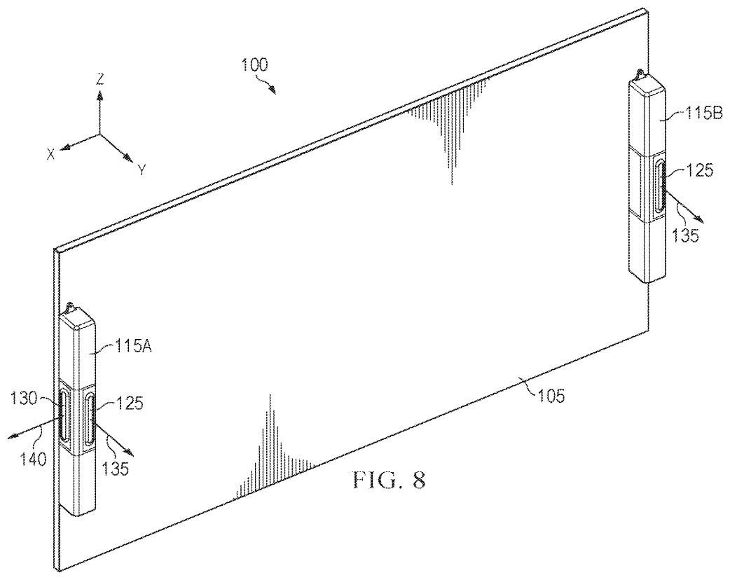

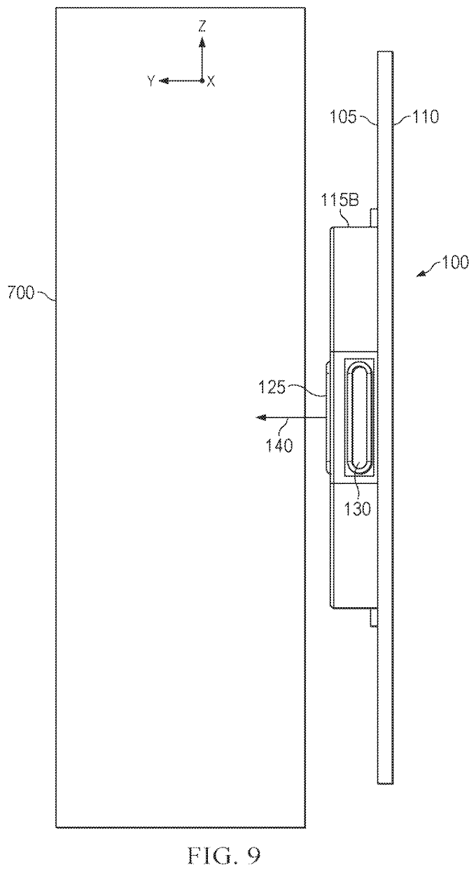

For example, FIGS. 8 and 9 illustrate perspective and side views of the display device 100 in which the speaker modules 115A, 115B are arranged in a second manner relative to the rear surface 105 of display device 100. In this second arrangement, the first speakers 125 included in speaker modules 115A, 115B are still rearward facing relative to the display device 100. However, as shown, the second speakers 130 are sideward, not downward, facing. That is, with respect to FIG. 8, the second speaker(s) 130 included in speaker module 115A emits sound energy to the left of the rear surface 105 of display device 100 (e.g., generally along the x-axis) and the second speaker(s) 130 included in speaker module 115B emits sound energy to the right of the rear surface 105 of display device 100 (e.g., generally along the x-axis). Accordingly, when a speaker module 115 is arranged in a second manner relative to the rear surface 105 of display device 100, the first speaker(s) 125 are rearward facing and the second speaker(s) 130 are sideward facing.

In some instances, (not illustrated), a speaker module 115 may be arranged such that the first speaker(s) 125 are rearward facing and the second speaker(s) 130 are upward facing. In such instances, the first speaker(s) 125 emit sound energy in a generally rearward direction towards a wall 700 behind the display device 100 and the second speaker(s) 130 emit sound energy in a generally upward direction towards a ceiling above the display device 100. In some instances, (not illustrated), a speaker module 115 may be arranged such that the first speaker(s) 125 and/or the second speaker(s) 130 are arranged to face in a direction that is diagonal to the rear surface 105 of display device 100.

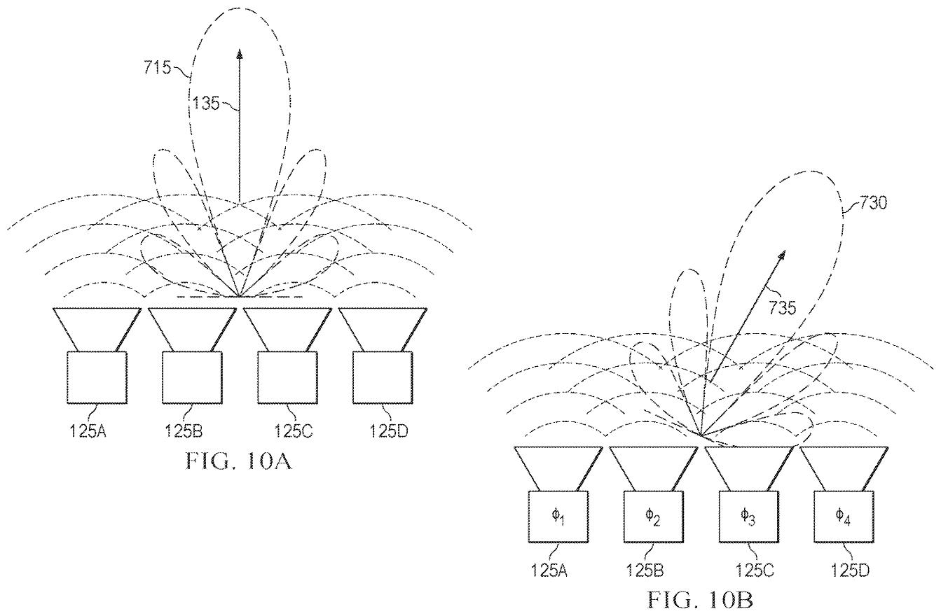

FIGS. 10A and 10B illustrate an exemplary effect of frequency dependent phase shifts and/or frequency dependent gains applied by BF filters onto sound energy emitted by speakers. It should be understood that these illustrated examples of FIGS. 10A and 10B are provided to assist with explaining the effects of applying phase shifts and/or complex gains to acoustically summed sound energy and in no way limit implementation of the proposed speakers and speaker modules described herein. Furthermore, although the illustrated examples of FIGS. 10A and 10B are described with respect to the first speakers 125A-125D and the first BF filters 175A-175D, it should be understood that the below description of “beam steering” is equally applicable to the second speaker(s) 130 and second BF filters 205. Further still, it should be understood that the below description of “beam steering” is also equally applicable to an acoustic summation of the combined sound energy emitted by the first speaker(s) 125 and the second speaker(s) 130. Moreover, it should be understood that the below description of “beam steering” is also equally applicable to an acoustic summation of the sound energy emitted by the first speaker(s) 125, the sound energy emitted by the second speaker(s) 130, and the sound energy reflected off surfaces (e.g., the wall 700, the supporting surface 705, the floor 710, etc.) adjacent to the display device 100.

FIG. 10A illustrates an example in which the first speakers 125A-125D are arranged in an equispaced, linear, co-planar array, and do not include any first BF filters 175A-175D. As shown, the first speakers 125A-125D emit a collective beam of first sound energy 715 that is generally directed in a straight, first direction 135 centered on the lateral median axis of the array. Since the first speakers 125A-125D do not include first BF filters 175 to apply phase shifts and/or complex gains to the emitted first sound energy 715, the acoustic sum of the emitted sound energy 715 is not steered in a desired direction.

Alternatively, FIG. 10B illustrates an example in which the first speakers 125A-125D are arranged in the same equispaced, linear, co-planar array as the example of FIG. 10A. However, the array of first speakers 125A-125D illustrated in FIG. 10B further include respective first BF filters 175A-175N that are configured to apply phase shifts #1-#4 to the sound energy emitted by the first speakers 125A-125D. In this simple example, #1 is a zero phase shift, #4 is an arbitrary large phase shift, and the phase shifts in between linearly increase from #1 to #4. As shown, the first BF filters 175A-175D are configured to apply phase shifts #1-#4 to the sound energy 715 emitted by the first speakers 125A-125D such that an acoustic sum of the emitted sound energy 715 is steered, or formed, into a target beam of sound energy 730 that travels in a target direction 735 (e.g., to the right). Accordingly, a target directionality of the sound energy emitted by first speakers 125A-125D can be achieved when the frequency dependent phase shifts and/or frequency dependent gains, which may hereinafter be interchangeably referred to as filter coefficients and/or parameters, applied by first BF filters 175A-175D are particularly designed for and selected.

With respect to an example in which the first speaker(s) 125 are rear firing and the second speakers 130 are down firing, the first BF filters 175 used to apply frequency dependent phase shifts and/or frequency dependent gains to the first sound energy 715 emitted by the rear firing first speakers 125 and the second BF filters 205 used to apply frequency dependent phase shifts and/or frequency dependent gains to the second sound energy 720 emitted by the down firing second speakers 130 are designed such that the acoustic sum of the emitted sound energy 715, 720 is directed in a beam that travels in the target direction 735 towards viewer 725. In such an example, the process for designing the BF filters 175, 205 considers the effects of sound energy that is reflected off surfaces proximate the display device 100, such as the wall 700 behind display device 100 and the surface 705 (e.g., a cabinet) underneath the display device 100. Furthermore, in such an example, the process for designing the BF filters 175, 205 may consider the effects of sound reflected off additional surfaces near display device 100, such as the floor 710, the ceiling, and/or the walls on either side of the display device 100. Considering the effects of surfaces adjacent to the display device 100 during the BF filter design process may include, for example, generating a 3-D model that includes the relative geometries (sizes of, distances between, etc.) of the display device 100, the speaker modules 115, and the surfaces adjacent to the display device 100 and using this 3-D model to simulate operation of the speaker modules 115. By using the 3-D model to simulate operation of the speaker modules 115 (e.g., performing FEM/BEM analysis on simulated operation of the speaker modules 115), the effects of sound reflections off surfaces adjacent the display device 100 are factored into the complex polar frequency responses of the speaker modules 115 that are solved for, or output, by the simulation. Accordingly, optimal BF filters 175, 205 can be designed based on these complex polar frequency responses that are derived based on interactions between sound energy emitted by the rear firing speakers 125, the down firing speakers 130, and the reflections of sound energy off surfaces adjacent to the display device 100. Similarly, for examples in which the first and second speakers 125, 130 are arranged to face in other directions, the effects of sound energy reflected off surfaces adjacent to the display device 100 may be considered in similar ways.

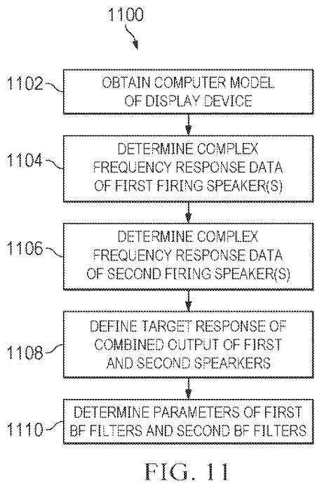

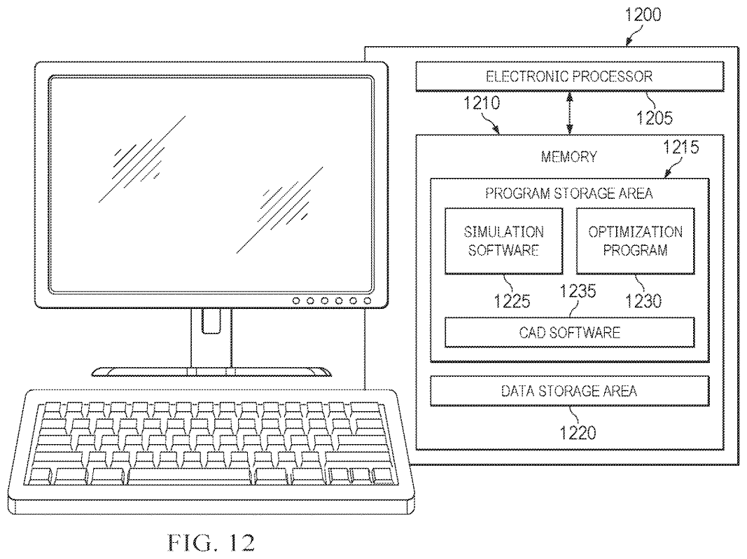

FIG. 11 provides a method 1100 for designing the BF filters 175, 205 included in a speaker module 115. For example, the BF filters 175, 205 are designed for the purpose of directing an acoustic sum of the combined sound energy emitted by a speaker module 115 (e.g., the first and second speakers 125, 130) in a target direction (e.g., towards the viewer of display device 100). Moreover, BF filters 175, 205 that are designed using method 1100 reduce a need for excessive EQ of sound energy emitted by the speaker module 115 and result in an improved direct-to-reverberant sound ratio at the position of the viewer of display device 100.

Although method 1100 is described with respect to a speaker module 115 that includes rear firing speaker(s) 125 and a down firing speaker(s) 130, it should be understood that method 1100 can be used to design BF filters for speaker modules that include speakers arranged in other orientations. For example, in some instances, method 1100 is used to design BF filters for speaker modules that include side and rear firing speakers or side and upward firing speakers. Furthermore, it should be understood that method 1100 can also be used to design each of the first BF filters 175A-175N and/or each of the second BF filters 205A-205N for instances in which the speaker module 115 includes a plurality of first speakers 125A-125N and/or a plurality of second speakers 130A-130N. Further still, it should be understood that method 1100 can be used to design BF filters for systems in which the display device 100 includes more than two speaker modules 115A, 115B.

As described above, in some examples, the speaker modules 115A, 115B included in display device 100 are identical in construction, and thus, the first BF filter(s) 175 and the second BF filter(s) 205 designed for a first speaker module 115A could also be used for a second speaker module 115B. Accordingly, in such examples, method 1100 is only performed once to design the first BF filter(s) 175 and the second BF filter(s). However, in some examples, such as when directional asymmetry exists in the target response of speaker modules 115A, 115B and/or when there are physical differences between the first speaker module 115A and the second speaker module 115B, the method 1100 is performed a first time to design the BF filters 175, 205 included in a first speaker module 115A and a second time to design the BF filters 175, 205 included in a second speaker module 115B.

In some instances, the method 1100 is performed by a computing device that includes a processor and a memory. For example, in an instance in which distances between the display device 100 and adjacent surfaces at the installation location of display device 100 are known, a computing device may be configured to perform method 1100 to design the BF filters 175, 205 before the display device 100 is installed. In other instances, as described above, the method 1100 is performed by a cloud-based processing device. For example, in an instance in which the display device 100 is moved from a first installation position to a second installation position, a cloud-based procedure for performing method 1100 may be used to dynamically update the BF filters 175, 205 included in the display device 100. In such an instance, the dynamically updated BF filters 175, 205 account for the effects of surfaces adjacent to the display device 100 when the display device 100 is installed in the second installation position. In some instances, operating data associated with the first and second speakers 125, 130 is measured and adjusted onsite using an experimental and/or real-time process for designing the BF filters 175, 205. For example, the complex frequency responses of the first and second speakers 125, 130 may be measured and adjusted for at respective evaluation points in space around the display device 100. In such instances, optimization of the BF filter 175, 205 can be achieved without the use of any computer modelling/cloud-based computations.

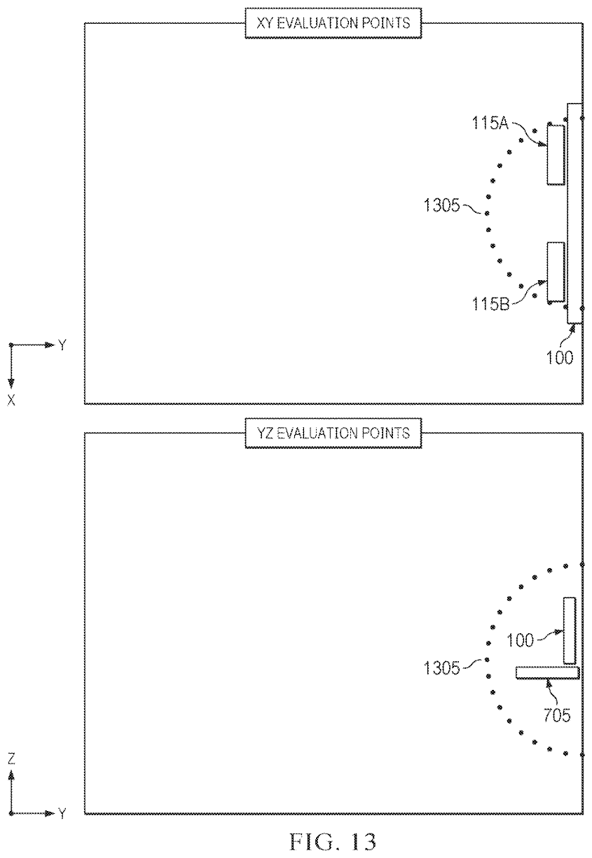

FIG. 12 illustrates an example computing device 1200 that may be used to perform method 1100. Although illustrated as a desktop computer, it should be understood that any suitable computing device that includes a processor and a memory may be used to perform method 1100. For example, method 1100 may alternatively be performed by a laptop computer, a tablet, a smartphone, a server, a cloud-based solution, or other similar computing device. As shown in FIG. 12, the computing device 1200 includes an electronic processor 1205 and a memory 1210. The memory 1210 includes, for example, a program storage area 1215 and a data storage area 1220. The program storage area 1215 stores one or more software programs and/or applications, such as computer-aided design (CAD) software 1235 (e.g., Solidworks, CREO, Inventor, NX, etc.), used for designing three-dimensional (3-D) CAD models of the display device 100, the speaker module 115, and/or the environment in which the display device 100 is located. The program storage area 1215 additionally stores one or more software programs and/or applications (e.g., MATLAB, LTSpice, Microcap, Simulink, COMSOL, etc.), such as simulation software 1225, used for finite element method (FEM) and/or boundary element method (BEM) analysis of a speaker module 115. In addition, the program storage area 1215 stores one or more software programs and/or applications (e.g., MATLAB, LTSpice, Microcap, Simulink, COMSOL, etc.), such as an optimization program 1230, used for optimizing parameters (e.g., complex gains etc.) of the BF filters 175, 205. In some instances, the optimization program 1230 is implemented as custom code written in a software such as MATLAB. The program storage area 1215 and the data storage area 1220 can include combinations of different types of memory, such as read-only memory (ROM) and/or random-access memory (RAM). Various non-transitory computer readable media, for example, magnetic, optical, physical, or electronic memory may be used.

The electronic processor 1205 is communicatively coupled to the memory 1210 and executes software programs and instructions that are stored in the memory 1210, or stored on another non-transitory computer readable medium such as another memory or a disc. The software may include one or more applications, program data, filters, rules, one or more program modules, and other executable instructions. For example, the software includes the simulation software 1225, the optimization program 1230, and/or the CAD software 1235. The software may include instructions, which when executed by processor 1205, cause the processor 1205 to simulate operation of the speaker module 115 using 3-D CAD model of the display device 100, speaker modules 115, and adjacent surfaces stored in the memory 1210. The software may also include instructions, which when executed by processor 1205, cause the processor to optimize parameters of the BF filters 175, 205 that result in the acoustic summation of sound energy emitted by the speaker module 115 being directed in a target direction.

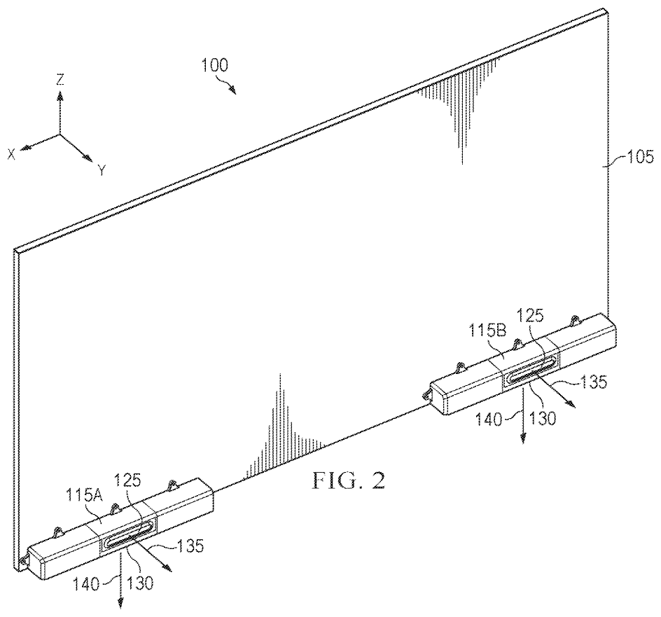

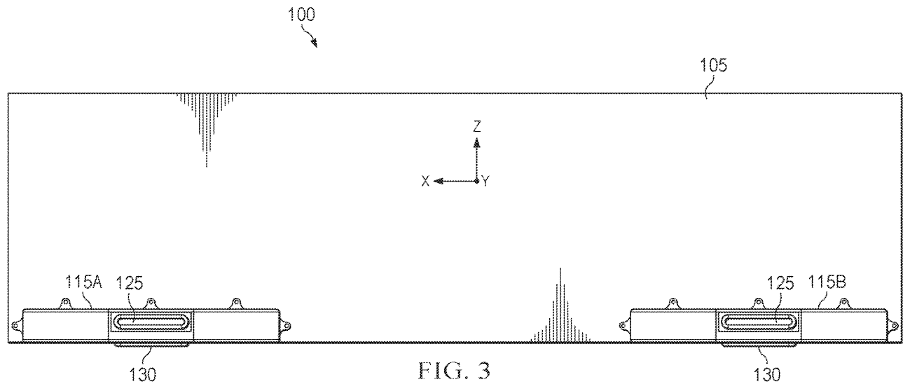

At step 1102, the processor 1205 generates, or obtains, a computer model of the display device 100 (e.g., a 3-D CAD model of the display device 100 illustrated in FIGS. 2-3) that is used to simulate operation of a speaker module 115. The computer model of the display device 100 includes, for example, a model of a first speaker module 115A. The model of the first speaker module 115A includes models of one or more first, or rear firing, speakers 125 and respective models of the back volume enclosures of the rear firing speaker(s) 125. The model of the first speaker module 115A includes models of one or more second, or down firing, speakers 130 and respective models of the back volume enclosures of the down firing speaker(s) 130. Furthermore, the model of the display device 100 includes, for example, a model of a second speaker module 115B. The model of the second speaker module 115B includes models of one or more first, or rear firing, speakers 125 and respective models of the back volume enclosures of the rear firing speaker(s) 125. The model of the second speaker module 115B further includes models of one or more second, or down firing, speakers 130 and respective models of the back volume enclosures of the down firing speaker(s) 130.

Moreover, the computer model of display device 100 includes one or more adjacent boundaries and/or surfaces. For example, the computer model of display device 100 may include models of boundary surfaces adjacent the display device 100, such as a wall 700 behind the display device 100, a surface 705 underneath the display device 100, a floor 710, a ceiling, furniture, and etc. In some instances, the step of obtaining the computer model of the display device 100 further includes loading the computer model of display device 100 into simulation software. When operation of a speaker module 115 is simulated, effects of the adjacent surfaces, such as phase shifts of reflected sound energy relative to the sound energy propagating directly from the rear and down firing speakers 125, are considered.

In some instances, obtaining a computer model of the display device 100 further includes determining an acceleration or a displacement frequency response of the respective diaphragms of rear firing speaker(s) 125 and the down firing speaker(s) 130 included a speaker module 115. In such instances, the processor 1205 defines the diaphragm acceleration or displacement frequency response of the rear firing speaker(s) 125 and the down firing speaker(s) 130 as an acceleration or displacement boundary condition that is used when simulating operation of a speaker module 115. In some instances, the diaphragm acceleration or displacement frequency response of the rear firing speaker(s) 125 and the down firing speaker(s) 130 is measured during operation of first and second speakers 125, 130 included in a physical prototype of a speaker module 115. For example, in such instances, the diaphragm acceleration frequency response and/or diaphragm displacement frequency response of the speakers 125, 130 may be measured using a Klippel laser Doppler vibrometer. In some instances, the processor 1205 predicts the diaphragm acceleration or displacement frequency response of the rear firing speaker(s) 125 and the down firing speaker(s) 130 by using a lumped element equivalent circuit model of the first and second speakers 125, 130. This lumped element equivalent circuit model of the first and second speakers 125, 130 may be added to the above-described computer model of display device 100 to determine the diaphragm acceleration frequency response.

As will be described in more detail below with respect to steps 1104 and 1106, the computer model of display device 100 is used to simulate operation of and determine the complex polar frequency responses of the rear and down firing speaker(s) 125, 130. In some instances, the computer model of display device 100 is a frequency domain, pressure acoustics model in which the solid objects (e.g., display device 100, speaker modules 115A, 115B, the wall 700, the surface 705, the floor 710 etc.) included in the computer model are treated as perfectly rigid. That is, only the physical medium (air) through which sound travels is modelled and the structural mechanics of the solid objects included in the computer model of display device 100 are not considered. In other instances, the structural mechanics of the solid objects included in the computer model of display device 100 are considered.

When simulating operation of the rear firing speaker(s) 125 and/or the down firing speaker(s) 130, the above-described acceleration or displacement boundary condition is used to simulate the steady-state, periodic acceleration or displacement of air on the respective diaphragms of the rear firing speaker(s) 125 and the down firing speaker(s) 130. Sound pressure is proportional to a volume acceleration of the air being moved by an exerting force (e.g., the force accelerating the diaphragms of the rear and down firing speaker(s) 125, 130). Thus, simulated operation of the rear firing speaker(s) 125 and the down firing speaker(s) 130 models the complex pressure values at a number of points throughout computational space. Since the computer model of display device 100 includes models of the surfaces adjacent the display device 100, the resultant complex pressure values at points throughout computational space include the effects of sound reflect off the wall 700, the surface 705, the floor 710, the ceiling, and other surfaces adjacent the display device 100.

As described above, in some instances, the processor 1205 uses FEM/BEM analysis techniques to simulate operation of the rear firing speaker(s) 125 and the down firing speaker(s) 130. In such instances, FEM/BEM analysis includes discretizing the computational space into “elements” of a specified size, shape and distribution. Given the material properties of the medium (air) through which the sound energy propagates, the FEM/BEM analysis then solves the Helmholtz wave equation at every element vertex. The result of the FEM/BEM analysis is a matrix of complex pressure values for a number of points in space, at the specified excitation frequencies. From this solution dataset, various representations of the data can be created, two of which are the complex polar frequency response of the speakers 125, 130 and the spatial pressure radiation pattern of the rear firing speaker(s) 125 and the down firing speaker(s) 130. In some instances, other analysis techniques are used to simulate operation of the rear firing speaker(s) 125 and the down firing speaker(s) 130.

At step 1104, the processor 1205 solves, or determines, the complex polar frequency response of the rear firing speaker(s) 125. In particular, the processor 1205 determines the complex polar frequency response of the rear firing speaker(s) 125 when sound energy emitted by the rear firing speaker(s) 125 is not filtered by optimized BF filters 175. Determining the complex polar frequency response of the rear firing speaker(s) 125 includes, for example, simulating operation of the rear firing speaker(s) 125 and evaluating the resultant complex pressure values of points in computational space across a wide range of frequencies (e.g., 20 Hz-20 kHz).

In some instances, the points in space that are used to determine the complex polar frequency response of the rear firing speaker(s) 125 are defined one or more spatial planes. For example, in some instances, the complex polar frequency response of the rear firing speaker(s) 125 is evaluated at a first set of points defined on the x-y plane and at a second set of points defined on the y-z plane. In such instances, the complex polar frequency response of rear firing speaker(s) 125 may be defined as a first table that includes data indicative of the complex pressure evaluated at the first set of points defined on the x-y plane and a second table that includes data indicative of the complex pressure evaluated at the second set of points defined on the y-z plane. It should be understood that although presented and described herein as being included in separate tables, in some instances, the complex frequency response of the rear firing speaker(s) 125 is represented as a single table that include data indicative of the complex pressure evaluated at the first set of points defined on the x-y plane and the complex pressure evaluated at the second set of points defined on the y-z plane. In some instances, the complex polar frequency response of the rear firing speaker(s) 125 is evaluated at one or more sets of points that are defined on different spatial planes. Furthermore, for instances in which the first speaker(s) 125 are not rear firing, evaluation points defined in other spatial planes may be used to determine the complex polar frequency response of the first speaker(s) 125. In some instances, the complex polar frequency response of the rear firing speaker(s) 125 is evaluated at other points, such as points in a spherical grid and/or points in a rectangular grid.

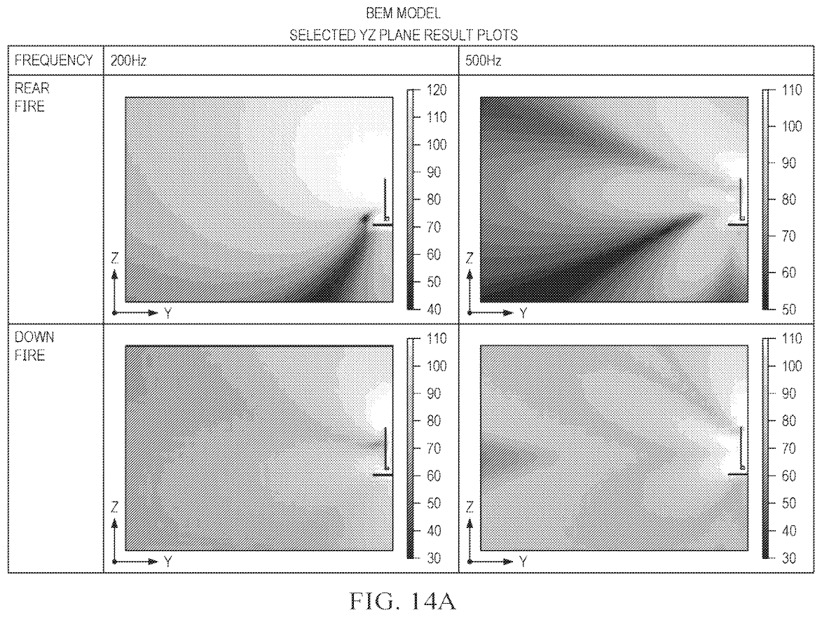

FIG. 13 illustrates an example in which the processor 1205 evaluates the complex polar frequency response of the rear firing speaker(s) 125 at a first set of nineteen discrete evaluation points 1305 on the x-y plane and at a second set of nineteen discrete evaluation points 1305 on the y-z plane. In the illustrated example, the first set of evaluation points 1305 on the x-y plane define an are that spans 180 degrees and has an origin of (0, 0) at a median point of display device 100. Similarly, the second set of evaluation points 1305 on the y-z plane define an arc that spans 180 degrees and has an origin of (0, 0) at a median point of display device 100. Although described as using sets of nineteen evaluation points to evaluate the complex polar frequency response in the x-y plane and the y-z plane, it should be understood that in some instances, sets of more or less than nineteen evaluation points may be used.

Table 1 is provided below as an example of a table, or matrix, of data that defines the complex polar frequency response of the rear firing speaker(s) 125 in the x-y plane. In this example, the processor 1205 evaluated the complex pressure at each of the nineteen evaluation points 1305 defined on the x-y plane (e.g., shown in FIG. 13) at 200 Hz, 500 Hz, 2 kHz, and 5 kHz. Accordingly, as shown, Table 1 includes the complex pressure phase and magnitude of the sound field radiating from rear firing speaker(s) 125 at each evaluation point 1305 on the x-y plane across the tested range of frequencies. For the sake of explanation, the data points are represented in Table 1 as polar coordinates (magnitude, phase). However, it should be understood that the data points may instead be written in a complex number form x+iy, where “i” represents an imaginary number.

Furthermore, it should be understood that Table 1 is provided merely as an example, and that the number of evaluation points and frequencies at which the complex polar frequency response of rear firing speaker(s) 125 are evaluated are not intended to limit implementation of the disclosure in any way. For example, in some instances, a log-spaced vector of 200 frequencies from 20 Hz to 16 kHz is used to evaluate the complex polar frequency response of the rear firing speaker(s) 125.

TABLE 1

| POINT | COMPLEX | COMPLEX | COMPLEX | COMPLEX |
|---|---|---|---|---|
| ON X-Y | PRESSURE | PRESSURE | PRESSURE | PRESSURE |
| PLANE | AT 200 HZ | AT 500 HZ | AT 2000 HZ | AT 5000 HZ |
| POINT 1 | (magnitude, | (magnitude, | (magnitude, | (magnitude, |
| | phase) | phase) | phase) | phase) |
| POINT 2 | (magnitude, | (magnitude, | (magnitude, | (magnitude, |
| | phase) | phase) | phase) | phase) |
| POINT 3 | (magnitude, | (magnitude, | (magnitude, | (magnitude, |
| | phase) | phase) | phase) | phase) |
| POINT 4 | (magnitude, | (magnitude, | (magnitude, | (magnitude, |
| | phase) | phase) | phase) | phase) |
| POINT 5 | (magnitude, | (magnitude, | (magnitude, | (magnitude, |
| | phase) | phase) | phase) | phase) |
| POINT 6 | (magnitude, | (magnitude, | (magnitude, | (magnitude, |
| | phase) | phase) | phase) | phase) |
| POINT 7 | (magnitude, | (magnitude, | (magnitude, | (magnitude, |
| | phase) | phase) | phase) | phase) |
| POINT 8 | (magnitude, | (magnitude, | (magnitude, | (magnitude, |
| | phase) | phase) | phase) | phase) |
| POINT 9 | (magnitude, | (magnitude, | (magnitude, | (magnitude, |
| | phase) | phase) | phase) | phase) |
| POINT 10 | (magnitude, | (magnitude, | (magnitude, | (magnitude, |
| | phase) | phase) | phase) | phase) |
| POINT 11 | (magnitude, | (magnitude, | (magnitude, | (magnitude, |
| | phase) | phase) | phase) | phase) |
| POINT 12 | (magnitude, | (magnitude, | (magnitude, | (magnitude, |
| | phase) | phase) | phase) | phase) |
| POINT 13 | (magnitude, | (magnitude, | (magnitude, | (magnitude, |
| | phase) | phase) | phase) | phase) |
| POINT 14 | (magnitude, | (magnitude, | (magnitude, | (magnitude, |
| | phase) | phase) | phase) | phase) |
| POINT 15 | (magnitude, | (magnitude, | (magnitude, | (magnitude, |
| | phase) | phase) | phase) | phase) |
| POINT 16 | (magnitude, | (magnitude, | (magnitude, | (magnitude, |
| | phase) | phase) | phase) | phase) |
| POINT 17 | (magnitude, | (magnitude, | (magnitude, | (magnitude, |
| | phase) | phase) | phase) | phase) |
| POINT 18 | (magnitude, | (magnitude, | (magnitude, | (magnitude, |
| | phase) | phase) | phase) | phase) |
| POINT 19 | (magnitude, | (magnitude, | (magnitude, | (magnitude, |
| | phase) | phase) | phase) | phase) |

Similarly, Table 2 is provided below as an example of a table, or matrix, of data that defines the complex frequency response of the rear firing speaker(s) 125 in the y-z plane. In this example, the processor 1205 evaluated the complex pressure at each of the nineteen evaluation points 1305 defined on the y-z plane (e.g., shown in FIG. 13) at 200 Hz, 500 Hz, 2 kHz, and 5 kHz. Accordingly, as shown, Table 2 includes the complex pressure phase and magnitude of the sound field radiating from rear firing speaker(s) 125 at each evaluation point 1305 on the y-z plane across the tested range of frequencies. For the sake of explanation, the data points are represented in Table 2 as polar coordinates (magnitude, phase). However, it should be understood that the data points may instead be written in a complex number form y+iz, where “i” represents an imaginary number.

Furthermore, it should be understood that Table 2 is provided merely as an example, and that the number of evaluation points and frequencies at which the complex polar frequency response of rear firing speaker(s) 125 was evaluated are not intended to limit implementation of the disclosure in any way. For example, in some instances, a log-spaced vector of 200 frequencies from 20 Hz to 16 kHz is used to the complex polar frequency response of the rear firing speaker(s) 125. In addition, it should be understood that although presented herein as separated tables, in some instances, Table 1 and Table 2 are combined into a single table that defines the complex frequency response of the rear firing speaker(s) 125. As will be described in more detail below, data points included in Tables 1 and 2 are provided as inputs to an optimization function that solves for parameters of the BF filters 175, 205.

TABLE 2

| POINT | COMPLEX | COMPLEX | COMPLEX | COMPLEX |
|---|---|---|---|---|
| ON Y-Z | PRESSURE | PRESSURE | PRESSURE | PRESSURE |
| PLANE | AT 200 HZ | AT 500 HZ | AT 2000 HZ | AT 5000 HZ |
| POINT 1 | (magnitude, | (magnitude, | (magnitude, | (magnitude, |
| | phase) | phase) | phase) | phase) |
| POINT 2 | (magnitude, | (magnitude, | (magnitude, | (magnitude, |
| | phase) | phase) | phase) | phase) |
| POINT 3 | (magnitude, | (magnitude, | (magnitude, | (magnitude, |
| | phase) | phase) | phase) | phase) |
| POINT 4 | (magnitude, | (magnitude, | (magnitude, | (magnitude, |
| | phase) | phase) | phase) | phase) |
| POINT 5 | (magnitude, | (magnitude, | (magnitude, | (magnitude, |
| | phase) | phase) | phase) | phase) |
| POINT 6 | (magnitude, | (magnitude, | (magnitude, | (magnitude, |
| | phase) | phase) | phase) | phase) |
| POINT 7 | (magnitude, | (magnitude, | (magnitude, | (magnitude, |
| | phase) | phase) | phase) | phase) |
| POINT 8 | (magnitude, | (magnitude, | (magnitude, | (magnitude, |
| | phase) | phase) | phase) | phase) |
| POINT 9 | (magnitude, | (magnitude, | (magnitude, | (magnitude, |
| | phase) | phase) | phase) | phase) |
| POINT 10 | (magnitude, | (magnitude, | (magnitude, | (magnitude, |
| | phase) | phase) | phase) | phase) |
| POINT 11 | (magnitude, | (magnitude, | (magnitude, | (magnitude, |
| | phase) | phase) | phase) | phase) |
| POINT 12 | (magnitude, | (magnitude, | (magnitude, | (magnitude, |
| | phase) | phase) | phase) | phase) |
| POINT 13 | (magnitude, | (magnitude, | (magnitude, | (magnitude, |
| | phase) | phase) | phase) | phase) |
| POINT 14 | (magnitude, | (magnitude, | (magnitude, | (magnitude, |
| | phase) | phase) | phase) | phase) |
| POINT 15 | (magnitude, | (magnitude, | (magnitude, | (magnitude, |
| | phase) | phase) | phase) | phase) |
| POINT 16 | (magnitude, | (magnitude, | (magnitude, | (magnitude, |
| | phase) | phase) | phase) | phase) |
| POINT 17 | (magnitude, | (magnitude, | (magnitude, | (magnitude, |
| | phase) | phase) | phase) | phase) |
| POINT 18 | (magnitude, | (magnitude, | (magnitude, | (magnitude, |
| | phase) | phase) | phase) | phase) |
| POINT 19 | (magnitude, | (magnitude, | (magnitude, | (magnitude, |
| | phase) | phase) | phase) | phase) |

At step 1106, the processor 1205 solves, or determines, the complex polar frequency response of the down firing speaker(s) 130. In particular, the processor 1205 determines the complex polar frequency response of the down firing speaker(s) 130 when the down firing speaker(s) 130 when the sound energy emitted by the down firing speaker(s) is not filtered optimized BE filters 205. Determining the complex polar frequency response of the down firing speaker(s) 130 includes, for example, simulating operation of the down firing speaker(s) 130 and evaluating the resultant complex pressure values of points in computational space across a wide range of frequencies (e.g., 20 Hz-20 kHz).

In some instances, the points in space that are used to determine the complex polar frequency response of the down firing speaker(s) 130 are defined one or more spatial planes. For example, in some instances, the complex polar frequency response of the down firing speaker(s) 130 is evaluated at a first set of points defined on the x-y plane and at a second set of points defined on the y-z plane. In such instances, the complex polar frequency response of down firing speaker(s) 130 may be defined as a first table that includes data indicative of the complex pressure evaluated at the first set of points defined on the x-y plane and a second table that includes data indicative of the complex pressure evaluated at the second set of points defined on the y-z plane. It should be understood that although presented and described herein as being included in separate tables, in some instances, the complex frequency response of the down firing speaker(s) 130 is represented as a single table that includes data indicative of the complex pressure evaluated at the first set of points defined on the x-y plane and the complex pressure evaluated at the second set of points defined on the y-z plane. In some instances, the complex polar frequency response of the down firing speaker(s) 130 is evaluated at one or more sets of points that are defined on different spatial planes. Furthermore, for instances in which the second speaker(s) 130 are not down firing, evaluation points defined in other spatial planes may be used to determine the complex polar frequency response of the second speaker(s) 130. In some instances, the complex polar frequency response of the down firing speaker(s) 130 is evaluated at other points, such as points in a spherical grid and/or points in a rectangular grid.

FIG. 13 illustrates an example in which the processor 1205 evaluates the complex polar frequency response of the down firing speaker(s) 130 at a first set of nineteen discrete evaluation points 1305 on the x-y plane and at a second set of nineteen discrete evaluation points 1305 on the y-z plane. In the illustrated example, the first set of evaluation points 1305 on the x-y plane define an are that spans 180 degrees and has an origin of (0, 0) at a median point of display device 100. Similarly, the second set of evaluation points 1305 on the y-z plane define an arc that spans 180 degrees and has an origin of (0, 0) at a median point of display device 100. Although described as using sets of nineteen evaluation points to evaluate the complex polar frequency response in the x-y plane and the y-z plane, it should be understood that in some instances, sets of more or less than nineteen evaluation points may be used.

Table 3 is provided below as an example of a table, or matrix, of data that defines the complex polar frequency response of the down firing speaker(s) 130 in the x-y plane. In this example, the processor 1205 evaluated the complex pressure at each of the nineteen evaluation points 1305 defined on the x-y plane (e.g., shown in FIG. 13) at 200 Hz, 500 Hz, 2 kHz, and 5 kHz. Accordingly, as shown, Table 3 includes the complex pressure phase and magnitude of the sound field radiating from down firing speaker(s) 130 at each evaluation point 1305 on the x-y plane across the tested range of frequencies. For the sake of explanation, the data points are represented in Table 3 as polar coordinates (magnitude, phase). However, it should be understood that the data points may instead be written in a complex number form x+iy, where “i” represents an imaginary number.

Furthermore, it should be understood that Table 3 is provided merely as an example, and that the number of evaluation points and frequencies at which the complex polar frequency response of down firing speaker(s) 130 are evaluated are not intended to limit implementation of the disclosure in any way. For example, in some instances, a log-spaced vector of 200 frequencies from 20 Hz to 16 kHz is used to evaluate the complex polar frequency response of the down firing speaker(s) 130.

TABLE 3

| POINT | COMPLEX | COMPLEX | COMPLEX | COMPLEX |
|---|---|---|---|---|
| ON X-Y | PRESSURE | PRESSURE | PRESSURE | PRESSURE |
| PLANE | AT 200 HZ | AT 500 HZ | AT 2000 HZ | AT 5000 HZ |
| POINT 1 | (magnitude, | (magnitude, | (magnitude, | (magnitude, |
| | phase) | phase) | phase) | phase) |
| POINT 2 | (magnitude, | (magnitude, | (magnitude, | (magnitude, |
| | phase) | phase) | phase) | phase) |
| POINT 3 | (magnitude, | (magnitude, | (magnitude, | (magnitude, |
| | phase) | phase) | phase) | phase) |
| POINT 4 | (magnitude, | (magnitude, | (magnitude, | (magnitude, |
| | phase) | phase) | phase) | phase) |
| POINT 5 | (magnitude, | (magnitude, | (magnitude, | (magnitude, |
| | phase) | phase) | phase) | phase) |
| POINT 6 | (magnitude, | (magnitude, | (magnitude, | (magnitude, |
| | phase) | phase) | phase) | phase) |
| POINT 7 | (magnitude, | (magnitude, | (magnitude, | (magnitude, |
| | phase) | phase) | phase) | phase) |
| POINT 8 | (magnitude, | (magnitude, | (magnitude, | (magnitude, |
| | phase) | phase) | phase) | phase) |
| POINT 9 | (magnitude, | (magnitude, | (magnitude, | (magnitude, |
| | phase) | phase) | phase) | phase) |
| POINT 10 | (magnitude, | (magnitude, | (magnitude, | (magnitude, |
| | phase) | phase) | phase) | phase) |
| POINT 11 | (magnitude, | (magnitude, | (magnitude, | (magnitude, |
| | phase) | phase) | phase) | phase) |
| POINT 12 | (magnitude, | (magnitude, | (magnitude, | (magnitude, |
| | phase) | phase) | phase) | phase) |
| POINT 13 | (magnitude, | (magnitude, | (magnitude, | (magnitude, |
| | phase) | phase) | phase) | phase) |
| POINT 14 | (magnitude, | (magnitude, | (magnitude, | (magnitude, |
| | phase) | phase) | phase) | phase) |
| POINT 15 | (magnitude, | (magnitude, | (magnitude, | (magnitude, |
| | phase) | phase) | phase) | phase) |
| POINT 16 | (magnitude, | (magnitude, | (magnitude, | (magnitude, |
| | phase) | phase) | phase) | phase) |
| POINT 17 | (magnitude, | (magnitude, | (magnitude, | (magnitude, |
| | phase) | phase) | phase) | phase) |
| POINT 18 | (magnitude, | (magnitude, | (magnitude, | (magnitude, |
| | phase) | phase) | phase) | phase) |
| POINT 19 | (magnitude, | (magnitude, | (magnitude, | (magnitude, |
| | phase) | phase) | phase) | phase) |

Similarly, Table 4 is provided below as an example of a table, or matrix, of data that defines the complex frequency response of the down firing speaker(s) 130 in the y-z plane. In this example, the processor 1205 evaluated the complex pressure at each of the nineteen evaluation points 1305 defined on the y-z plane (e.g., shown in FIG. 13) at 200 Hz, 500 Hz, 2 kHz, and 5 kHz. Accordingly, as shown, Table 4 includes the complex pressure phase and magnitude of the sound field radiating from down firing speaker(s) 130 at each evaluation point 1305 on the y-z plane across the tested range of frequencies. For the sake of explanation, the data points are represented in Table 4 as polar coordinates (magnitude, phase). However, it should be understood that the data points may instead be written in a complex number form y+iz, where “i” represents an imaginary number.

Furthermore, it should be understood that Table 4 is provided merely as an example, and that the number of evaluation points and frequencies at which the complex polar frequency response of down firing speaker(s) 130 was evaluated are not intended to limit implementation of the disclosure in any way. For example, in some instances, a log-spaced vector of 200 frequencies from 20 Hz to 16 kHz is used to the complex polar frequency response of the down firing speaker(s) 130. In addition, it should be understood that although presented herein as separated tables, in some instances, Table 3 and Table 4 are combined into a single table that defines the complex frequency response of the down firing speaker(s) 130. As will be described in more detail below, data points included in Tables 3 and 4 are provided as inputs to an optimization function that solves for parameters of the BF filters 175, 205.

TABLE 4

| POINT | COMPLEX | COMPLEX | COMPLEX | COMPLEX |
|---|---|---|---|---|
| ON Y-Z | PRESSURE | PRESSURE | PRESSURE | PRESSURE |
| PLANE | AT 200 HZ | AT 500 HZ | AT 2000 HZ | AT 5000 HZ |
| POINT 1 | (magnitude, | (magnitude, | (magnitude, | (magnitude, |
| | phase) | phase) | phase) | phase) |
| POINT 2 | (magnitude, | (magnitude, | (magnitude, | (magnitude, |
| | phase) | phase) | phase) | phase) |
| POINT 3 | (magnitude, | (magnitude, | (magnitude, | (magnitude, |
| | phase) | phase) | phase) | phase) |
| POINT 4 | (magnitude, | (magnitude, | (magnitude, | (magnitude, |
| | phase) | phase) | phase) | phase) |
| POINT 5 | (magnitude, | (magnitude, | (magnitude, | (magnitude, |
| | phase) | phase) | phase) | phase) |
| POINT 6 | (magnitude, | (magnitude, | (magnitude, | (magnitude, |
| | phase) | phase) | phase) | phase) |
| POINT 7 | (magnitude, | (magnitude, | (magnitude, | (magnitude, |
| | phase) | phase) | phase) | phase) |
| POINT 8 | (magnitude, | (magnitude, | (magnitude, | (magnitude, |
| | phase) | phase) | phase) | phase) |
| POINT 9 | (magnitude, | (magnitude, | (magnitude, | (magnitude, |
| | phase) | phase) | phase) | phase) |
| POINT 10 | (magnitude, | (magnitude, | (magnitude, | (magnitude, |
| | phase) | phase) | phase) | phase) |
| POINT 11 | (magnitude, | (magnitude, | (magnitude, | (magnitude, |
| | phase) | phase) | phase) | phase) |
| POINT 12 | (magnitude, | (magnitude, | (magnitude, | (magnitude, |
| | phase) | phase) | phase) | phase) |
| POINT 13 | (magnitude, | (magnitude, | (magnitude, | (magnitude, |
| | phase) | phase) | phase) | phase) |
| POINT 14 | (magnitude, | (magnitude, | (magnitude, | (magnitude, |
| | phase) | phase) | phase) | phase) |
| POINT 15 | (magnitude, | (magnitude, | (magnitude, | (magnitude, |
| | phase) | phase) | phase) | phase) |
| POINT 16 | (magnitude, | (magnitude, | (magnitude, | (magnitude, |
| | phase) | phase) | phase) | phase) |
| POINT 17 | (magnitude, | (magnitude, | (magnitude, | (magnitude, |
| | phase) | phase) | phase) | phase) |
| POINT 18 | (magnitude, | (magnitude, | (magnitude, | (magnitude, |
| | phase) | phase) | phase) | phase) |
| POINT 19 | (magnitude, | (magnitude, | (magnitude, | (magnitude, |
| | phase) | phase) | phase) | phase) |

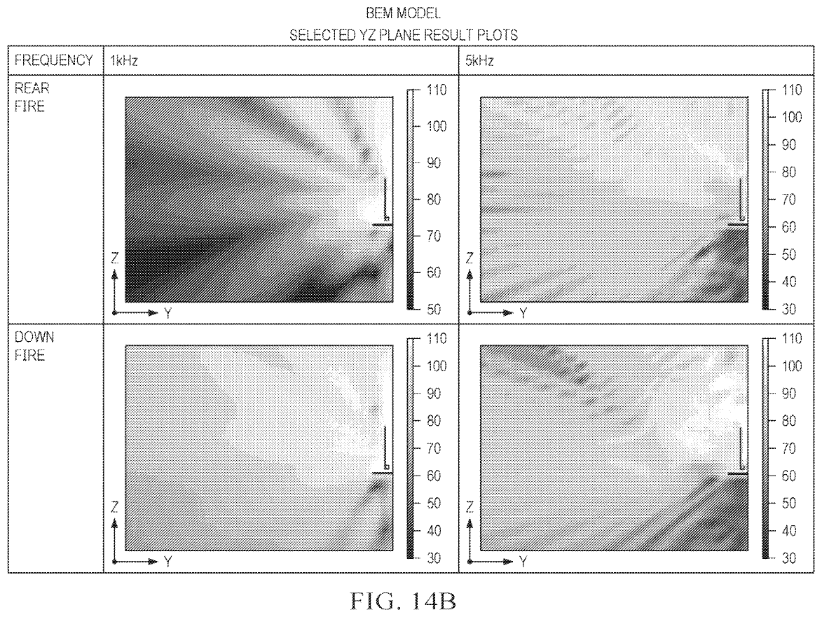

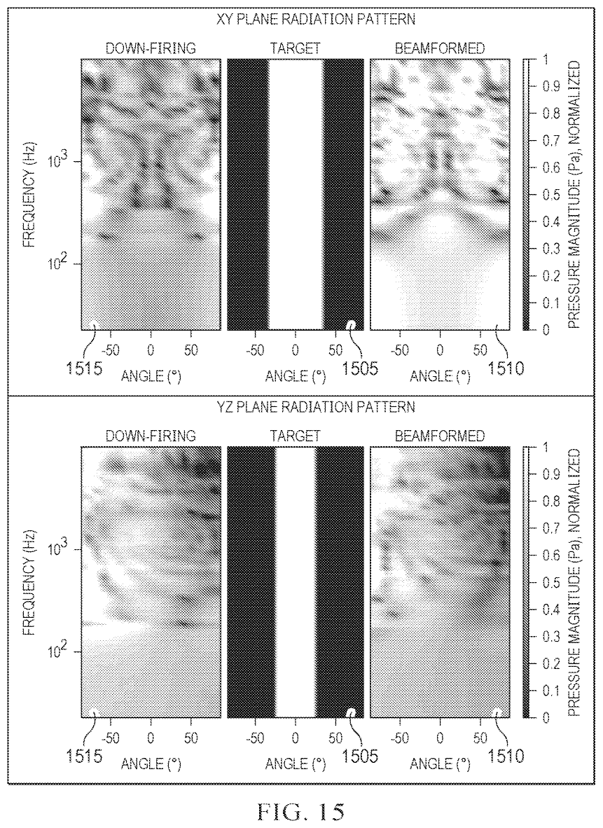

FIGS. 14A and 14B illustrate examples of the 200 Hz radiation pattern of the rear firing and down firing speaker(s) 125, 130 in the y-z plane, the 500 Hz radiation pattern of the rear firing and down firing speaker(s) 125, 130 in the y-z plane, the 1 kHz radiation pattern of the rear firing and down firing speaker(s) 125, 130 in the y-z plane, and the 5 kHz radiation pattern of the rear firing and down firing speaker(s) 125, 130 in the y-z plane. In particular, the plots of FIGS. 14A and 14B illustrate the respective spatial pressure radiation patterns of either only the rear firing speaker(s) 125 that are not filtered by optimized BF filters 175 or only the down firing speaker(s) 130 that are not optimized by BF filter 205. FIGS. 14A-14B do not illustrate the radiation pattern of the combined output of rear firing and down firing speakers 125, 130 that are respectively filtered by optimized BF filters 175, 205. In other words, FIGS. 14A-14B illustrate the respective outputs of the first and second speakers 125, 130 before the first and second speakers 125, 130 are tuned by optimized BF filters 175, 205. By comparison, examples of the radiation pattern of the combined output of the rear firing and down firing speaker 125, 130 that are respectively filtered by optimized BF filters 175, 205 are described below and illustrated in FIG. 15.

At step 1108, a target response of the combined sound energy emitted by the rear and down firing speakers 125, 130 is determined, or defined. The target response is a target complex polar frequency response of the total system, which includes the sound energy emitted by the first and second speakers 125, 130 and the effects of sound energy reflected off adjacent surfaces and boundaries, is defined. It should be understood that there are not separate target responses for each of the first speaker(s) 125 and the second speaker(s) 130 included in the speaker module 115. Rather, the target response is specified for the total, beamformed system. The total beamformed system refers to the beamformed acoustic summation of the filtered outputs of the first and second speaker(s) 125, 130, in combination with the sound reflected off adjacent surfaces, that is directed towards the viewers 725. In some instances, a respective target response of the total system is defined for each plane in space that the model is evaluated at (e.g., a target response of the total system on the x-y plane and a target response of the total system in the y-z plane).

The target response of the combined output of the rear and down firing speakers 125, 130 is defined at the same evaluation points in space that are used for determining the complex polar frequency responses of the rear and down firing speakers 125, 130. For example, the target response is defined as a single table of target complex pressure data that corresponds to the above described Tables 1-4 that define the complex polar frequency responses of the rear and down firing speaker(s) 125, 130. In some instances, the target response of the system in the x-y plane is represented by a first table and the target response of the system in the y-z plane is represented by a second table.

In some instances, the target response of the sound energy emitted by the rear and down firing speakers 125, 130 is defined as complex polar frequency response that results in an improved direct-to-reverberant ratio at the position of viewers 725 of the display device 100. In some instances, the target response is defined as a complex polar frequency response that results in an acoustic summation of sound energy emitted by the rear and down firing speakers 125, 130 being directed in a beam towards the viewer 725 with an intended amount of constructive and destructive interferences.

In the illustrated examples described herein, the target response of the sound energy emitted by the rear and down firing speakers 125, 130 is symmetric from left to right with respect to the display device 100. Accordingly, only the target response of a single speaker module 115 needs to be determined. This is advantageous when compared to systems in which the target response of sound energy emitted by the rear and down firing speakers 125, 130 is asymmetric from left to right with respect to the display device 100, as asymmetric systems require separate target responses for each speaker module 115 included in the display device 100 to be calculated, thereby greatly reducing the computational efficiency of the BF filter design process.

At step 1110, the processor 1205 determines a first set of parameters of the first BF filter(s) 175 and a second set of parameters of the second BF filter(s) 205 based on the target response and the complex polar frequencies determined at steps 1104 and 1106. For example, the processor 1205 determines a first set of parameters of the first BF filter(s) 175 and a second set of parameters of the second BF filter(s) 205 that minimize the difference between the target response and the summation of the complex polar frequency responses of the rear and down firing speaker(s) 125, 130 determined at steps 1104, 1106. The first set of parameters of the first BF filter(s) 175 includes, for example, phase shifts gains, and other multipliers applied by the first BF filter(s) 175 to the sound energy emitted by the rear firing speaker(s) 125. Similarly, the second set of parameters of the second BF filter(s) 205 include, for example, phase shifts and gains applied by the second BF filter(s) 205 to the sound energy emitted by the down firing speaker(s) 130. The first and second sets of BF filter parameters may also be referred to as coefficients.

In some instances, determining a first set parameters for the first BF filters 175 and a second set of parameters for the second BF filters 205 includes executing an optimization routine. For example, in some instances, the processor 1205 executes a function that is designed to minimize the difference between complex polar frequency response of the beamformed system (e.g., the acoustic summation of the rear and down firing speakers 125, 130, with BF filters applied) and the target response of the system defined in step 1108. Equation 1 below provides an expression for a complex polar frequency response of the beamformed system, which can be used by an optimization function to solve for BF filter parameters that minimize a difference between the target response and the complex polar frequency response of the beamformed system.

$${H}_{system} ( ω ) = {P}_{rf} ( ω ) \cdot {H}_{rf} ( ω ) + {P}_{df} ( ω ) \cdot {H}_{df} ( ω ) \qquad [ Equation 1 ]$$

In Equation 1, H_{system} is the total beamformed system response and w is the angular frequency. P_{rf} is the complex frequency response of the rear firing speaker(s) 125 that was determined at step 1104. P_{df} is the complex frequency response of the down firing speaker(s) 130 that was determined at step 1106. H_{rf} represents the first BF filter(s) 175, which is being solved for, as a complex gain applied to the rear firing speaker(s) 125. Similarly, H_{df} represents the second BF filter(s) 205, which is being solved for, as a complex gain applied to the down firing speaker(s) 130. Accordingly, the system response is modeled as a function of frequency that is equal to the sum of the product of the complex polar frequency response of the rear firing speaker(s) 125 and the complex gain of the first BF filter(s) 175 and the sum of the product of the complex polar frequency response of the down firing speaker(s) 130 and the complex gain of the second BF filter(s) 205.

As described above, an objective of the optimization routine used to solve for the BF filter parameters (e.g., the complex gains of the first and second BF filters 175, 205) that minimize the difference between the beamformed system response and the target response. Equation 2 below provides an optimization function that is to be iteratively solved by processor 1205 to determine a solution for the first and second BF filters 175, 205.

$$minimize ( {H}_{system} ( ω ) - {H}_{target} ( ω ) ) \qquad [ Equation 2 ]$$

$$\{ \begin{matrix}ω ϵ [ 0 , π ] \\ subject to \vert h ( ω , n ) \vert \leq {g}_{max}\end{matrix} \}$$

In Equation 2, H_{target} is the target response defined in step 1108 of method 1100. Furthermore, gₘₐₓ is an optimization constraint that prevents the processor 1205 from determining a solution that results in excessive system gain. As in the complex polar frequency responses determined at steps 1104 and 1106, the optimization variable is a table, or matrix, of complex gains h(ω, n), where ω is the number of frequencies and n is the number of speakers included in the system. In some instances, the optimization equation is further restricted by a minimum gain restraint.

The processor 1205 iteratively solves the optimization function until a solution for H_{rf} and H_{df} results in a difference between the system response and the target response that satisfies an error threshold. In some instances, the error threshold is a maximum allowable percentage difference between the system response and the target response (e.g., a 1% difference).

In some instances, the outputs of the above-described optimization functions are not sets of filter coefficients in a traditional sense. That is, in some instances, the determined solutions for H_{rf} and H_{df} are not time domain multipliers that can be applied to the rear and down firing speakers 125, 130. Rather, H_{rf} and H_{df} are the respective complex frequency response solutions of the first BF filter(s) 175 and the second BF filter(s) 205. In such instances, the BF filters 175, 205 are implemented as complex frequency responses H_{rf} and H_{df} in the frequency domain to process audio content that will be played back by the rear and down firing speakers 125, 130. For example, the complex frequency responses H_{rf} and H_{df} are multiplied by Fast Fourier Transforms (FFT) of the audio content that is to be played back by the rear and down firing speakers 125, 130 thereby filtering the audio content. Moreover, filtering audio content in this manner results in phase shifts and/or complex gains to be applied to the sound energy emitted by the rear and down firing speakers 125, 130 such that an acoustic sum of the emitted sound energy is steered in a targeted beam towards the viewer 725.

In some instances, the processor 1205 converts the complex frequency responses, H_{rf} and H_{df}, that were solved for using the optimization function into respective finite impulse response (FIR) filter coefficients. The FIR filter coefficients are used to define the first and second BF filters 175, 205 when implemented as digital filters in a low-latency DSP. In some instances, the optimization function is modified such that the output of the optimization function returns respective sets of FIR filter coefficients, and not the complex frequency responses H_{rf} and H_{df}.

FIG. 15 illustrates an example comparison between a target response 1505, a spatial pressure radiation pattern of the acoustic summation of sound energy 1510 emitted by the rear firing and down firing speakers 125, 130 in which the emitted sound energy is filtered by BF filters 175, 205 that were designed using method 1100, an an example spatial pressure radiation pattern of sound energy 1515 emitted by down firing speaker(s) 130 in which the sound energy 1515 is not filtered by any beam-forming filters. As shown, the acoustic summation of the filtered sound energy 1510 emitted by the rear firing and down firing speakers 125, 130 more closely tracks the target response 1505 when compared to an acoustic summation of sound energy 1515 emitted by down firing speaker(s) 130 that do not include any beam-forming filters.

The speaker modules 115 described herein may be implemented using one or more of any known types of loudspeakers. For example, first and/or second firing speakers 125, 130 described herein may be implemented as moving-iron loudspeakers, piezoelectric speakers, magnetostatic loudspeakers, magnetostrictive loudspeakers, electrostatic loudspeakers, ribbon and planar magnetic loudspeakers, bending wave loudspeakers, and/or flat panel loudspeakers. Other known types of loudspeakers may also be used.

The above speaker systems and speaker design methods may provide for an improved listening experience for television viewers. Systems, methods, and devices in accordance with the present disclosure may take any one or more of the following configurations.

### Effects

Systems, methods, and devices in accordance with the present disclosure may take any one or more of the following configurations.

(1) A display device including a first surface that supports a display and a second surface disposed opposite to first surface. A first speaker module is supported by the second surface and includes a first speaker arranged to face in a first direction relative to the display device and a second speaker arranged to face in a second direction relative to the display device, the second direction being different than the first direction. A second speaker module is supported by the rear surface and includes a third speaker arranged to face in the first direction and a fourth speaker arranged to face in the second direction.

(2) The display device according to (1), wherein the first speaker module further includes a first filter configured to apply at least one of a frequency dependent phase shift or a frequency dependent gain to a first sound energy emitted by the first speaker and a second filter configured to apply at least one of a frequency dependent phase shift or a frequency dependent gain to a second sound energy emitted by the second speaker.

(3) The display device according to (2), wherein an acoustic summation of the first sound energy emitted by the first speaker and the second sound energy emitted by the second speaker is steered in a target direction.

(4) The display device according to (3), wherein the acoustic summation further includes a summation of the sound energy reflected off a surface adjacent to the display device.

(5) The display device according to any one of (1) to (4), wherein the first speaker includes a plurality of first speakers and wherein the second speaker includes a plurality of second speakers.

(6) The display device according to (5), wherein the first speaker module further includes a plurality of first filters, wherein each one of the plurality of first filters is configured to apply at least one of a respective frequency dependent phase shift and a respective frequency dependent gain to sound energy emitted by a corresponding one of the plurality of first speakers, and a plurality of second filters, wherein each one of the plurality of second filters is configured to apply at least one of a respective frequency dependent phase shift and a respective frequency dependent gain to sound energy emitted by a corresponding one of the plurality of second speakers.

(7) The display device according to (6), wherein a first acoustic summation of sound energy emitted by the plurality of first speakers is steered in a first target direction on a first spatial plane and wherein a second acoustic summation of sound energy emitted by the plurality of second speakers is steered in a second target direction on a second spatial plane.

(8) The display device according to (6), wherein an acoustic summation of a first combined sound energy emitted by the first plurality of speakers and a second combined sound energy emitted by the second plurality of speakers is steered in a target direction.

(9) The display device according to (2), wherein the first filter and the second filter are implemented as digital filters in a digital signal processor.

(10) The display device according to any one of (1) to (9), wherein a first acoustic back volume of the first speaker is separate from a second acoustic back volume of the second speaker.

(11) A method for designing filters included in a speaker module for a display device. The speaker module includes a first speaker oriented to face in a first direction, a second speaker oriented to face in a second direction orthogonal to the first direction, a first filter connected to the first speaker, and a second filter connected to the second speaker. The method includes obtaining a three-dimensional computer model of the speaker module that includes a model of the first speaker and a model of the second speaker, determining a first complex polar frequency response of the first speaker based on the computer model of the speaker module, and determining a second complex polar frequency response of the second speaker based on the computer model of the speaker module. The method further includes defining a target response of a combined output of the first and second speakers, determining a first set of parameters of the first filter based on the target response and the first and second complex polar frequency responses, and determining a second set of parameters of the second filter based on the target response and the first and second complex polar frequency responses.

(12) The method according to (11), wherein determining the first complex polar frequency response includes evaluating a complex pressure of sound energy emitted by the first speaker at a first set of points in space and evaluating a complex pressure of sound energy emitted by the first speaker at a second set of points in space.

(13) The method according to (12), wherein the first set of points are defined on an x-y plane relative to the speaker module and the second set of points are defined on a y-z plane relative to the speaker module.

(14) The method according to any one of (11) to (13), wherein determining the second complex polar frequency response includes evaluating a complex pressure of sound energy emitted by the second speaker at a first set of points in space and evaluating a complex pressure of sound energy emitted by the second speaker at a second set of points in space.

(15) The method according to (14), wherein the first set of points are defined on an x-y plane relative to the speaker module and the second set of points are defined on a y-z plane relative to the speaker module.

(16) The method according to any one of (11) to (15), wherein the first set of parameters for the first filter includes a first complex gain applied by the first filter onto sound energy emitted by the first speaker.

(17) The method according to any one of (11) to (16), wherein the first filter is a finite impulse response filter implemented by a digital signal processor.

(18) The method according to any one of (11) to (17), wherein the second set of parameters for the second filter includes a second complex gain applied by the second filter onto sound energy emitted by the second speaker.

(19) The method according to any one of (11) to (18), wherein the second filter is a finite impulse response filter implemented by a digital signal processor.

(20) A non-transitory computer-readable medium storing instructions that, when executed by a processor, cause the processor to perform operations comprising the method according to any one of (11) to (19).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain instances, and should in no way be construed so as to limit the claims.

Accordingly, it is to be understood that the above description is intended to be illustrative and not restrictive. Many instances and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future instances. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various instances for the purpose of streamlining the disclosure. This method of disclosure is not to be interpreted as reflecting an intention that the claimed instances incorporate more features than are expressly recited in each claim. Rather, as the following claims reflect, inventive subject matter lies in less than all features of a single disclosed instance. Thus the following claims are hereby incorporated into the Detailed Description, with each claim standing on its own as a separately claimed subject matter.

1. A display device comprising:
a first surface that supports a display;
a second surface disposed opposite to the first surface; and
a first speaker module supported by the second surface, the first speaker module including:
a first speaker arranged to emit sound energy in a first direction relative to the display device;
a second speaker arranged to emit sound energy in a second direction relative to the display device,
the second direction being different than the first direction;
wherein the first speaker module comprises digital filters in a digital signal processor, wherein the digital filters are configured to define a target response of a combined output of the first and second speakers such that a beamformed acoustic summation of the sound energy emitted by the first speaker and the sound energy emitted by the second speaker is generally formed in a target direction away from the first surface of the display device towards a viewer of the display device, the target direction being different than the first and second directions.

2. The display device according to claim 1, wherein the digital filters include:
a first filter configured to apply at least one of a first frequency dependent phase shift and a
first frequency dependent gain to a first sound energy emitted by the first speaker; and
a second filter configured to apply at least one of a second frequency dependent phase shift
and a second frequency dependent gain to a second sound energy emitted by the second speaker.

3. The display device according to claim 2, wherein the digital filters are configured to steer an acoustic summation of the first sound energy emitted by the first speaker and the second sound energy emitted by the second speaker in the target direction.

4. The display device according to claim 3, wherein the acoustic summation further includes a summation of the sound energy reflected off a surface adjacent to the display device.

5. The display device according to claim 1, wherein the first speaker includes a plurality of first speakers; and
wherein the second speaker includes a plurality of second speakers.

6. The display device according to claim 5, wherein the first speaker module further includes:
a plurality of first filters, wherein each one of the plurality of first filters is configured to
apply at least one of a respective frequency dependent phase shift and a respective frequency dependent gain to sound energy emitted by a corresponding one of the plurality of first speakers; and
a plurality of second filters, wherein each one of the plurality of second filters is configured
to apply at least one of a respective frequency dependent phase shift and a respective frequency dependent gain to sound energy emitted by a corresponding one of the plurality of second speakers.

7. The display device according to claim 6, wherein the first filters are
configured to steer a first acoustic summation of sound energy emitted by the plurality of first speakers in a first target direction on a first spatial plane; and
wherein the second filters are configured to steer a second acoustic summation of
sound energy emitted by the plurality
of second speakers in a second target direction on a second spatial plane.

8. The display device according to claim 6, wherein the first and second filters are configured to steer an acoustic summation of a first combined sound energy emitted by the plurality of first speakers and a second combined sound energy emitted by the plurality of second speakers in the target direction.

9. The display device according to claim 1, wherein a first acoustic back volume of the first speaker is separate from a second acoustic back volume of the second speaker.

10. The display device according to claim 1, further comprising a second speaker module supported by the second surface, the second speaker module including:
a third speaker arranged to emit sound energy in the first direction; and
a fourth speaker arranged to emit sound energy in the second direction.

11. The display device according to claim 1, wherein the first filter or the second filter is a finite impulse response filter.

12. (canceled)

13. A method for designing filters included in a speaker module for a display device, the display device comprising a first surface that supports a display and a second surface disposed opposite to the first surface; the speaker module being supported by the second surface and including a first speaker oriented to emit sound energy in a first direction, a second speaker oriented to emit sound energy in a second direction, a first filter connected to the first speaker, and a second filter connected to the second speaker, the method comprising:
obtaining a three-dimensional computer model of the speaker module that includes a model of the first speaker and a model of the second speaker;
determining a first complex polar frequency response of the first speaker based on the computer model of the speaker module;
determining a second complex polar frequency response of the second speaker based on the computer model of the speaker module;
defining a target response of a combined output of the first and second speakers, the target response being that a beamformed acoustic summation of the sound energy emitted by the first speaker and the sound energy emitted by the second speaker is generally formed in a target direction away from a display of the display device towards a viewer of the display device, the target direction being different than the first and second directions;
determining a first set of parameters of the first filter based on the target response and the first and second complex polar frequency responses; and
determining a second set of parameters of the second filter based on the target response and the first and second complex polar frequency responses,
wherein the first and second filters comprise digital filters in a digital signal processor.

14. The method according to claim 13, wherein determining the first complex polar frequency response includes:
evaluating a complex pressure of sound energy emitted by the first speaker at a first set of points in space; and
evaluating a complex pressure of sound energy emitted by the first speaker at a second set of points in space.

15. The method of claim 14, wherein the first set of points are defined on an x-y plane relative to the speaker module and the second set of points are defined on a y-z plane relative to the speaker module.

16. The method according to claim 13, wherein determining the second complex polar frequency response includes:
evaluating a complex pressure of sound energy emitted by the second speaker at a first set of points in space; and
evaluating a complex pressure of sound energy emitted by the second speaker at a second set of points in space.

17. The method according to claim 16, wherein the first set of points are defined on an x-y plane relative to the speaker module and the second set of points are defined on a y-z plane relative to the speaker module.

18. The method according to claim 13, wherein the first set of parameters for the first filter includes a first complex gain applied by the first filter onto sound energy emitted by the first speaker.

19. The method according to claim 13, wherein the first filter or the second filter is a finite impulse response filter.

20. The method according to claim 13, wherein the second set of parameters for the second filter includes a second complex gain applied by the second filter onto sound energy emitted by the second speaker.

21. (canceled)

22. A non-transitory computer-readable medium storing instructions that, when executed by a processor, cause the processor to perform operations comprising the method according to claim 13.
